(19) United States
(12) Patent Application Publication
(10) Pub. No.: US 2021/0409619 A1
(43) Pub. Date: Dec. 30, 2021

(54) CAMERA, METHOD FOR PROCESSING IMAGE, PROGRAM, AND COMPUTER-READABLE STORAGE MEDIUM CONTAINING PROGRAM

(71) Applicant: SHARP KABUSHIKI KAISHA, Osaka (JP)

(72) Inventors: Satoru YAMAMOTO, Osaka (JP); TAZUKO KITAZAWA, Osaka (JP)

(21) Appl. No.: 17/357,708

(22) Filed: Jun. 24, 2021

(30) Foreign Application Priority Data
Jun. 25, 2020 (JP) 2020-109921

(51) Int. Cl. H04N 5/33; H04N 5/222; H04N 9/04

(52) U.S. Cl. CPC H04N 5/332; H04N 9/04557; H04N 5/2226

(57) ABSTRACT

Provided is a camera capable of accurately calculating a foreground image. An infrared camera includes: a first detection unit including a plurality of first detection elements configured to detect an electromagnetic wave having a first wavelength range; a second detection unit including a plurality of second detection elements capable of detecting an electromagnetic wave emitted from an inside of a housing, wherein the electromagnetic wave having at least one of wavelengths within a second wavelength range; a first transparent member disposed to correspond to the second detection elements is transparent for the second wavelength range; a second transparent member transparent for a third wavelength range from an outside to the inside of the housing; and the first wavelength range including at least one wavelength overlapping a wavelength within the third wavelength range, and the second wavelength range not overlapping the third wavelength range.

### CROSS-REFERENCE TO RELATED APPLICATION

The present application claims priority from Japanese Application JP2020-109921, the content of which is hereby incorporated by reference into this application.

### BACKGROUND OF THE INVENTION

### 1. Field of the Invention

The present invention relates to a camera, a method for processing an image, a program, and a computer-readable storage medium containing the program.

An infrared camera includes a detector array in which infrared-detectable elements are two-dimensionally arranged. The infrared camera can detect brightness of infrared light from an object. On the basis of the detected brightness, the infrared camera can calculate a temperature of the object.

However, a problem of the infrared camera is that, in actually capturing an object to be measured, the infrared camera simultaneously Obtains an image of infrared light emitted from the object and an image of infrared light emitted from other than the object.

In order to overcome this problem, a conventionally known technique is described in Japanese Unexamined Patent Application Publication No. 2015-212695. This technique involves simultaneously measuring an image of an object (m×n) and a reference image (1×n), and performing offset correction using the image of the object and the reference image.

Moreover, as described in Japanese Unexamined Patent Application Publication No. 2017-126812, another known technique utilizes a function to open and close a shutter at high speed. The technique involves obtaining an image of an object when the shutter is open and an image of the shutter (the background) when the shutter is closed, and performing offset correction on the image of the object, using the image of the shutter.

Furthermore, as described in Japanese Unexamined Patent Application Publication No. H10-262178, still another know technique involves detecting infrared light of a plurality of wavelengths by time division, and correcting a result of detecting the infrared light of one of the wavelengths with a result of detecting the infrared light of another one of the wavelengths.

### SUMMARY OF THE INVENTION

In the technique described in Japanese Unexamined Patent Application Publication No. 2015-212695, two-dimensional dispersion is calculated from a one-dimensional reference image. This technique poses a problem of limiting a shape of the background to be removed, such that the background cannot be accurately removed.

Moreover, the technique described in Japanese Unexamined Patent Application Publication No. 2017-126812 requires a shutter to open and close at high speed, inevitably increasing moving parts and possibly causing frequent breakdowns. As a result, it would be difficult to perform accurate offset correction.

Furthermore, the technique described in Japanese Unexamined Patent Application Publication No. H10-262178 cannot simultaneously detect infrared light of a plurality of wavelengths, making it difficult to correct the infrared light of the wavelengths accurately.

Hence, an aspect of the present invention provides to a camera capable of accurately calculating a foreground image.

Furthermore, another aspect of the present invention provides a method for processing an image. The method is capable of accurately calculating a foreground image.

Moreover, still another aspect of the present invention provides a program to let a computer calculate a foreground image accurately.

In addition, yet still another aspect of the present invention provides a computer-readable storage medium containing a program to let a computer calculate a foreground image accurately.

First Configuration

According to an embodiment of the present invention, a camera includes: a first detection unit; a second detection unit; a first transparent member; a second transparent member; and a calculator. The first detection unit includes a plurality of first detection elements arranged two-dimensionally and configured to detect an electromagnetic wave having a first wavelength range. The second detection unit includes a plurality of second detection elements arranged two-dimensionally and capable of detecting an electromagnetic wave emitted from an inside of a housing of the camera. The electromagnetic wave has at least one wavelength within a second wavelength range. The first transparent member is disposed to correspond to the second detection elements and capable of transmitting an electromagnetic wave having at least the one wavelength within the second wavelength range. The second transparent member is capable of transmitting an electromagnetic wave within a third wavelength range from an outside to the inside of the housing. The calculator can calculate image information from a first detection value detected by the first detection unit and a second detection value detected by the second detection unit. The first wavelength range includes at least one wavelength overlapping a wavelength having the third wavelength range. The second wavelength range does not overlap the third wavelength range.

Second Configuration

In the first configuration, the first detection elements and the second detection elements are arranged in mutually different positions in an imaging region.

Third Configuration

In the first configuration or the second configuration, the first detection elements and the second detection elements are made of the same detection elements. Each of the first detection elements is provided with an optical filter. The optical filter has a transmissive wavelength range defined as the first wavelength range.

Fourth Configuration

In any one of the first configuration to the third configuration, the first detection elements and the second detection elements are quantum-dot-based detection elements.

Note that the quantum-dot-based detection elements use quantum dots or quantum wells as photoelectric conversion elements. Moreover, the quantum dots are semiconductor particles having a particle size of 100 nm or less. Furthermore, the quantum wells are formed of semiconductor films having a thickness of 100 nm or less, and sandwiched between semiconductors whose bandgap is larger than those forming the quantum wells.

Fifth Configuration

In the fourth configuration, the quantum-dot-based detection elements include: a first quantum-dot-based detection element; and a second quantum-dot-based detection element. To the first quantum-dot-based detection element, a first voltage is applied. The first quantum-dot-based detection element detects an electromagnetic wave, emitted from an object, in the third wavelength range at least partially including the first wavelength range. To the second quantum-dot-based detection element, a second voltage that is different from the first voltage is applied. The second quantum-dot-based detection element detects an electromagnetic wave, emitted from an inside of the housing, in the second wavelength range.

Sixth Configuration

In any one of the first configuration to the fifth configuration, a ratio in number of the first detection elements to the second detection elements is equal to “64” to “one or less”.

Seventh Configuration

In any one of the first configuration to the sixth configuration, the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel vale, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

Eighth Configuration

In the seventh configuration, the first detection elements and the second detection elements are arranged in an N_{y}×Nₓ matrix in the imaging region. The image processing region includes: a first image processing region including the background image including k×Nₓ background images arranged in a k×Nₓ matrix or N_{y}×k background images arranged in an N_{y}×k matrix, and disposed along a row or a column of the imaging region; and a second image processing region including the background image including k×k background images arranged in a k×k matrix, and positioned on an extension of a diagonal of the imaging region. The calculator executes a third processing on all of background pixels including the background pixel within the first image processing region, and a fourth processing on all of background pixels including the background pixel within the second image processing region, the third processing involving calculating a background pixel value of a first target background image so that, when, in the first processing, the background images in the imaging region includes a first background image disposed in the same row or the same column as, and closest to, the first target background image to calculate a background image pixel value in the first image processing region, a difference in background pixel value from a fourth background pixel value that is a background pixel value of the first background image becomes: large if a first image interval that is an image interval between the first background image and the first target background image becomes long; and small if the first image interval becomes short, and the fourth processing involving calculating a sixth background pixel value, an eighth background pixel value, and an average of the sixth background pixel value and the eight background pixel value as a background pixel value of a second target background pixel, the sixth background pixel value being calculated so that, when the background images in the first image processing region includes a second background image disposed in the same row as, and closest to, the second target background image to calculate a background pixel value in the second image processing region, and when the background images in the first image processing region include a third background image disposed in the same column as, and closest to, the second target background image, a difference in background pixel value from a fifth background pixel value that is a background pixel value of the second background image becomes: large if a second image interval that is an image interval between the second background image and the second target background image becomes long; and small if the second image interval becomes short, and the eighth background pixel value being calculated so that, a difference in background pixel value from a seventh background pixel value that is a background pixel value of the third background image becomes: large if a third image interval that is an image interval between the third background image and the second target background image becomes long; and small if the third image interval becomes short.

Ninth Configuration

In the eighth configuration, the calculator further executes denoising in the first processing after the third processing and the fourth processing.

Tenth Configuration

In any one of the first configuration to the ninth configuration, the electromagnetic wave detected by the first detection unit, the electromagnetic wave detected by the second detection unit, and the electromagnetic wave within the third wavelength are infrared light.

Eleventh Configuration

According to another embodiment of the present invention, a method for processing an image includes: a first step of calculating a second background pixel value in accordance with a first background pixel value, the first background pixel value being a pixel value, of a background image, detected by a plurality of second detection elements, and the second background pixel value being a background pixel value in an image processing region outside an imaging region; a second step of interpolating, in accordance with the first background pixel value and the second background pixel value, a background pixel value of an image corresponding to a plurality of first detection elements, and calculating a third background pixel value that is a background pixel value of all the imaging region; a third step of interpolating an image pixel value of an image corresponding to the second detection elements and calculating an image pixel value of all the imaging region, the interpolating being performed in accordance with an image pixel value, of an captured image, detected by the first detection elements; a fourth step of subtracting the third background pixel value from the calculated image pixel value to calculate a foreground image; and a fifth step of executing denoising on the second background pixel value after executing the first step and before executing the second step.

Twelfth Configuration

According to still another embodiment of the present invention, a program causes a computer to execute: a first step of calculating a second background pixel value in accordance with a first background pixel value, the first background pixel value being a pixel value, of a background image, detected by a plurality of second detection elements, and the second background pixel value being a background pixel value in an image processing region outside an imaging region; a second step of interpolating, in accordance with the first background pixel value and the second background pixel value, a background pixel value of an image corresponding to a plurality of first detection elements, and calculating a third background pixel value that is a background pixel value of all the imaging region; a third step of interpolating an image pixel value of an image corresponding to the second detection elements and calculating an image pixel value of all the imaging region, the interpolating being performed in accordance with an image pixel value, of an captured image, detected by the first detection elements; a fourth step of subtracting the third background pixel value from the calculated image pixel value to calculate a foreground image; and a fifth step of executing denoising on the second background pixel value after executing the first step and before executing the second step.

Thirteenth Configuration

According to still another embodiment of the present invention, a storage medium is a computer-readable storage medium containing the program according to the twelfth configuration.

An aspect of the present invention makes it possible to accurately calculate a foreground image.

### BRIEF DESCRIPTION OF THE DRAWINGS

FIG. 1 is a schematic view of an infrared camera according to a first embodiment of the present invention;

FIG. 2 is a drawing illustrating how to arrange detection elements for image and detection elements for background image in FIG. 1;

FIGS. 3A and 3B are conceptual illustrations;

FIGS. 4A and 4B are drawings illustrating a relationship between a filter array and a detector array;

FIG. 5 is a drawing illustrating how to process an image;

FIG. 6 is a conceptual illustration of how to interpolate an imaging pixel;

FIGS. 7A and 7B are drawings illustrating a preprocess 1;

FIG. 8 is a drawing illustrating a preprocess 2;

FIG. 9 is a flowchart showing how to calculate a foreground image;

FIG. 10 is a flowchart showing specific operations at Step S2 in FIG. 9;

FIG. 11 is a flowchart showing specific operations at Step S3 in FIG. 9;

FIG. 12 is a flowchart showing specific operations at Step S4 in FIG. 9;

FIG. 13 is a flowchart showing specific operations at Step S5 in FIG. 9;

FIGS. 14A-14D show images of a first verification experiment;

FIGS. 15A-15F show images that have undergone image processing in the first verification experiment;

FIGS. 16A-16E show images of a second verification experiment;

FIGS. 17A-17D show images that have undergone image processing in the second verification experiment;

FIG. 18 is a schematic view of an infrared camera according to a second embodiment;

FIG. 19 is a plan view illustrating a detector array in FIG. 18;

FIG. 2l is a conceptual illustration of how to interpolate an aging pixel with another technique;

FIG. 21 is a drawing illustrating another technique of how to calculate a background pixel value in an image processing region 2; and

FIG. 22 is a conceptual illustration showing a relationship between wavelength ranges of infrared light according to embodiments of the present invention.

### DETAILED DESCRIPTION OF THE INVENTION

Described below are embodiments of the present invention, with reference to the drawings. Note that identical reference signs are used to denote identical or substantially identical components throughout the drawings. Such components will not be repeatedly elaborated upon.

### First Embodiment

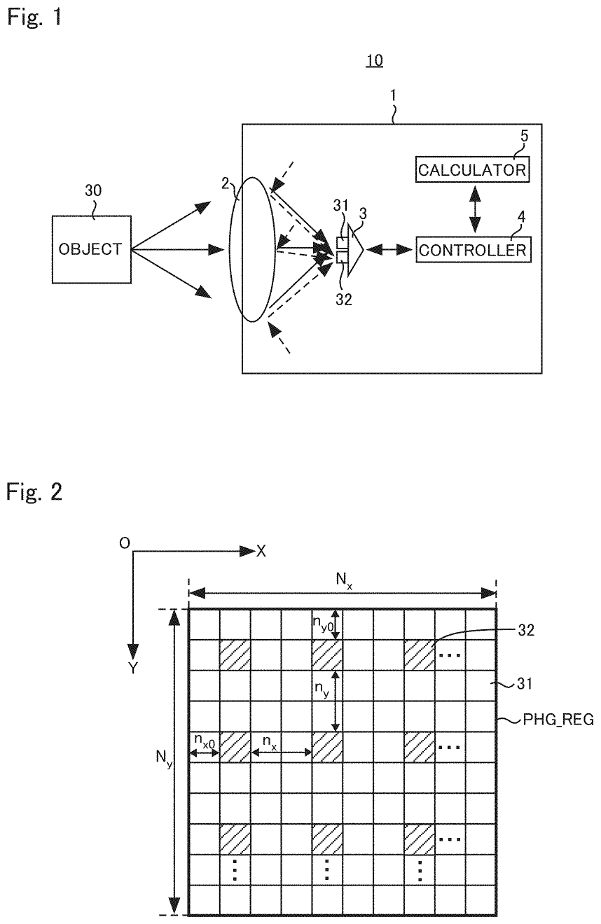

FIG. 1 is a schematic view of an infrared camera according to a first embodiment of the present invention. With reference to FIG. 1, an infrared camera 10 according to the first embodiment of the present invention includes: a housing 1; a lens 2; a detector array 3; a controller 4; and a calculator 5. The detector array 3 includes: detection elements for image 31 (hereinafter referred to as imaging elements 31); and detection elements for background image 32 (hereinafter referred to as background elements 32).

The lens 2 is disposed to a side of the housing 1 toward an object 30. The lens 2 focuses infrared light emitted from the object 30 on the detector array 3, and allows infrared light in a specific wavelength range (a transmissive wavelength range) to transmit. The infrared light transmitting through the lens 2 enters the detector array 3. The function to transmit infrared light having a specific wavelength is not necessarily achieved by the lens 2. Alternatively, for example, such a function may be achieved by an infrared filter provided inside the housing 1.

The detector array 3, an array of detection elements arranged in two dimensions, is included in a detection unit. Here, the detector array 3 includes the imaging elements 31 and the background elements 32. A detector array serving as (or including) the imaging elements 31 (first detection elements) is a first detection unit, and a detector array serving as (or including) the background elements 32 (second detection elements) is a second detection unit. The imaging elements 31 and the background elements 32 may be provided separately. Note that, as described in the embodiments of the present invention, the imaging elements 31 and the background elements 32 can be provided integrally. Such a feature makes it possible to reduce the space and optical components.

Each of the imaging elements 31 detects incident infrared light having a detection wavelength λ1, and outputs the detected value to the controller 4. The detection wavelength λ1 includes a transmissive wavelength range of the lens 2. Hence, the detection wavelength λ1 may match the transmissive wavelength range of the lens 2. The detection wavelength λ1 ranges, for example, from 8 to 10 μm.

Each of the background elements 32 detects incident infrared light having a detection wavelength λ2, and outputs the detected value to the controller 4. The detection wavelength λ2 does not include the transmissive wavelength range of the lens 2. Hence, the detection wavelength λ2 does not have to include the detection wavelength λ1. The detection wavelength λ2 ranges, for example, from 10 to 11 μm.

The controller 4 controls the imaging element 31 and the background element 32 to simultaneously detect brightness of the object 30 and brightness of the housing 1 (brightness of the background).

Moreover, the controller 4 receives a detection value D1 from the imaging element 31, and outputs the received detection value D1 to the calculator 5. Simultaneously, the controller 4 receives a detection value D2 from the background element 32, and outputs the received detection value D2 to the calculator 5.

The calculator 5 receives the detection values D1 and D2 from the controller 4, and, in accordance with the received detection values D1 and D2, calculates a foreground image by a method to be described later.

FIG. 2 is a drawing illustrating how to arrange the imaging elements 31 and the background elements 32 in FIG. 1. In FIG. 2, an X-Y plane is defined. When the imaging elements 31 and the background elements 32 are vertically and horizontally arranged with a ratio of “8” to “1 or below”, an image of the object 30 can be accurately captured without deteriorating an image captured by the imaging elements 31. Hence, a ratio of the imaging elements 31 to the background elements is preferably “64”: “1 or below”.

Of the imaging elements 31 and the background elements 32 in FIG. 2, a detection element at the top-left end (0, 0) is determined as the origin. A detection element at a top-right end is determined as (Nₓ₋₁, 0), a detection element at a bottom-left end is determined as (Nₓ₋₁, N_{y-1}), and a detection element at a bottom-right end is determined as (Nₓ₋₁, N_{y-1}).

As a result, the imaging elements 31 and the background elements 32 are arranged in an N_{y}×Nₓ matrix (in two dimensions) in an imaging region PHG_REG. Each of the Nₓ and the N_{y} is an integer of two or larger. The Nₓ may be either the same as, or different from, N_{y}.

The background elements 32 are arranged at predetermined intervals in a row (an X-axis) direction and a column (a Y-axis) direction. More specifically, the background elements 32 are arranged in the row (the X-axis) direction at an interval of no from an end of the imaging region PHG_REG, and at an interval of nₓ between the neighboring background elements 32. Furthermore, the background elements 32 are arranged in the column (the Y-axis) direction at an interval of n_{y0} from an end of the imaging region PHG_REG, and at an interval of n_{y} between the neighboring background elements 32. In such a case, for example, a relationship of nₓ₀<nₓ and n_{y0}<n_{y} holds. Note that the relationship of nₓ₀<nₓ and n_{y0}<n_{y} does not have to necessarily hold. If a relationship of nₓ₀>nₓ or n_{y0}>n_{y} holds, techniques of a preprocess 1 and a preprocess 2 may be used to interpolate a pixel value of the imaging region PHG_REG. Note that all of the elements other than the background elements 32 are the imaging elements 31.

Note that, as an embodiment, the imaging elements 31 and the background elements 32 illustrated in FIG. 2 are arranged in mutually different positions. Such an arrangement makes it possible to simultaneously capture the object and the background images. Furthermore, because the background elements 32 and the imaging elements 31 are provided to the same detector array 3, the background image (attributed to the infrared light that the housing 1 emits, a temperature of the detector, and a thermal environment of surroundings) captured by the background elements 32 becomes closest to the background image also captured by the imaging elements 31. That is, such an arrangement makes it possible to remove the background image of the imaging elements 31 most accurately. Moreover, the arrangement also makes it possible to reduce the space inside the housing 1, contributing to further reduction of optical components.

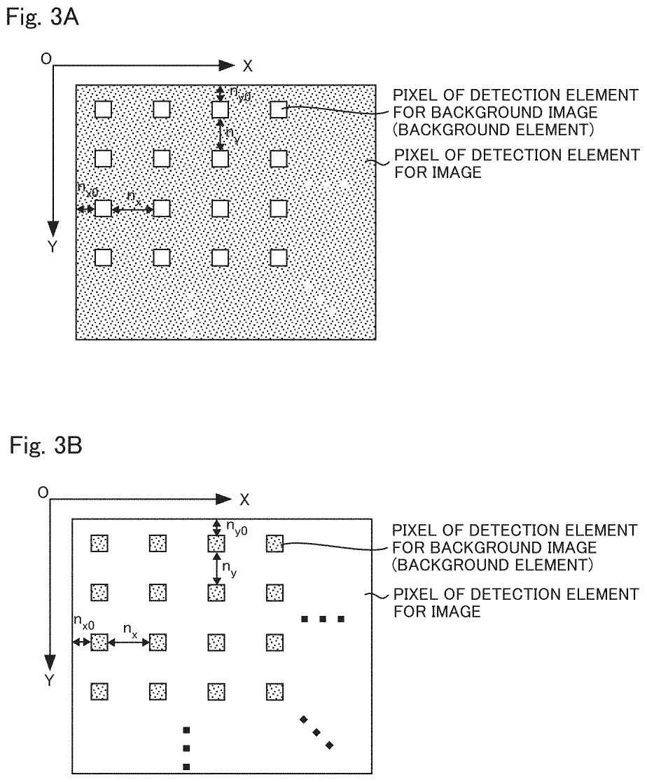

FIGS. 3A and 3B are conceptual illustrations of pixels. FIG. 3A shows a captured image generated from the detection values D1 of the imaging elements 31. FIG. 3B shows a background image generated from the detection values D2 of the background elements 32.

The detection values D1 of the imaging elements 31 and the detection values D2 of the background elements 32 form an image of Nₓ×N_{y}.

Pixel coordinates are determined so that the imaging region PHG_REG and detection element numbers (imaging element 31 numbers and background element 32 numbers) correspond to each other. That is, top-left end pixel coordinates are (0, 0), top-right end pixel coordinates are (Nₓ₋₁,0), bottom-left end pixel coordinates are (0, N_{y-1}), and bottom-right end pixel coordinates are (Nₓ₋₁, N_{y-1}).

According to the embodiments of the present invention, appropriate image processing is separately performed on the captured image generated from the detection values D1 of the imaging elements 31 and on the background image generated from the detection values D2 of the background elements 32.

In the captured image seen in FIG. 3A, a detection value D1 of an imaging element 31 converted into a pixel value is referred to as an image pixel value. Moreover, in the background image seen in FIG. 3B, a detection value D2 of a background element 32 converted into a pixel value is referred to as a background pixel value.

Note that, in the images of FIGS. 3A and 3B, only the pixels with the pixel values input therein are hatched, and the pixels with no pixel values input therein are blank.

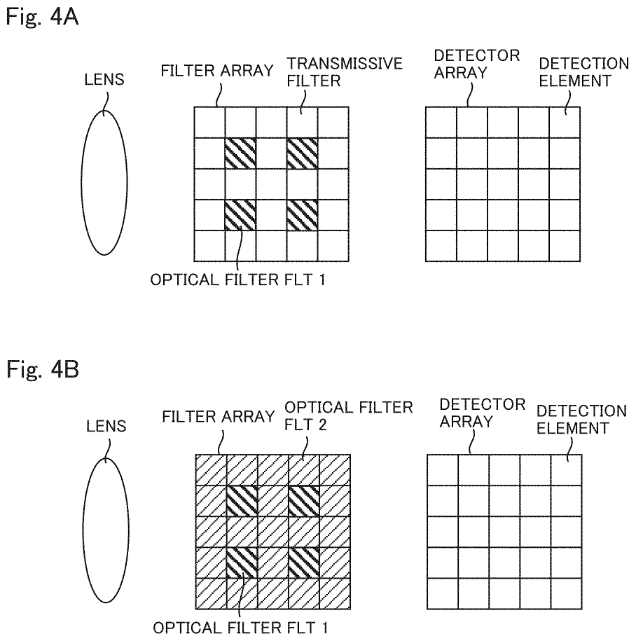

FIGS. 4A and 4B are drawings illustrating a relationship between a filter array and a detector array. With reference to FIGS. 4A and 4B, detection elements (the imaging elements 31 and the background elements 32) included in the detector array include, for example: a detection element performing photoelectric conversion in a bandgap of InGaAs; a detection element in which a thermal detector such as a thermopile and a bolometer is equipped with an optical filter; a quantum-dot-based-detection element performing photoelectric conversion, using energy levels in multilayer quantum dots; and a quantum-well detection element performing photoelectric conversion, using energy levels in multilayer quantum wells. In the first embodiment, the detector array 3 includes an infrared detection element whose detection wavelength is constant.

For example, such devices as an InGaAs sensor and a bolometer have a preset detection wavelength depending on a detection element, and the detection wavelength cannot be changed. Moreover, a detection element having a variable detection wavelength may also be included in the detector array 3, using this configuration.

Described below is a combination of a lens, a filter array, and a detection element. In the configuration in FIG. 4A, a transmissive wavelength of the lens 2 defines the detection wavelength λ1. The imaging element 31 is formed of a detection element and a transmissive filter attached to the detection element. The transmissive filter may be transparent at least to the detection wavelength λ1, or may be omitted.

The background element 32 is formed of a detection element and an optical filter FLT 1 attached to the detection element. The optical filter FLT 1 is transparent to the detection wavelength λ2, and blocks infrared light in the transmissive wavelength range of the lens 2. Thanks to such a feature, the background element 32 detects not light transmitted through the lens 2; that is, infrared light from the object 30, but the background light alone.

In the configuration in FIG. 4B, an optical filter FLT 2 defines the detection wavelength λ1. The imaging element 31 is formed of a detection element and the optical filter FLT 2 attached to the detection element. The optical filter FLT 2 is transparent to some or all of the detection wavelengths of the detection wavelengths λ1 and λ2. Such a feature makes it possible to obtain a detector (the imaging element 31) provided with the optical filter FLT 2 capable of detecting the light transmitted through the lens 2, and a detector (the background element 32) provided with the optical filter FLT 1 unaffected by the light transmitted through the lens 2.

Specifically, when the transmissive wavelength range of the optical filter FLT 2 is equal to the detection wavelength λ1, a brightness of a foreground image in the detection value of the imaging element 31 becomes greatest. Hence, an image of the calculated foreground has a high signal-to-noise ratio (S/N). That is, the optical filter limits the detection wavelength of the imaging element 31, making it possible to adjust an intensity of the infrared light emitted from the object 30 and incident on the imaging element 31 and an intensity of the infrared light emitted from the background and incident on the imaging element 31. Furthermore, for example, the optical filter limits the detection wavelength of the imaging element 31 equivalent to the detection wavelength range of the imaging element 31 with the transmissive wavelength range of the lens 2. The equalization makes it possible to maximize the intensity of the infrared light emitted from the object 30 and incident on the imaging element 31, and to minimize the intensity of the infrared light emitted from the background and incident on the imaging element 31. Such a feature makes it possible to maximize the signal and minimize the noise. In other words, the feature improves the S/N. The above advantageous effects can be achieved by equalizing the detection wavelength range of the imaging element 31 with the transmissive wavelength range of the lens 2. However, the detection wavelength range and the transmissive wavelength range do not have to be completely equivalent to each other. The rate of the overlapping range is increased such that the advantageous effects can be achieved in accordance with the increased rate.

The background element 32 is formed of a detection element and the optical filter FLT 1 attached to the detection element. The optical filter FLT 1 is transparent to the detection wavelength λ2, and blocks infrared light in the transmissive wavelength range of the lens 2. Thanks to such a feature, the background element 32 detects not light transmitted through the lens 2; that is, infrared light from the object 30, but the background light alone.

Note that, in FIGS. 4A and 4B, each of the regions in the filter array corresponds one of the regions of the detector array.

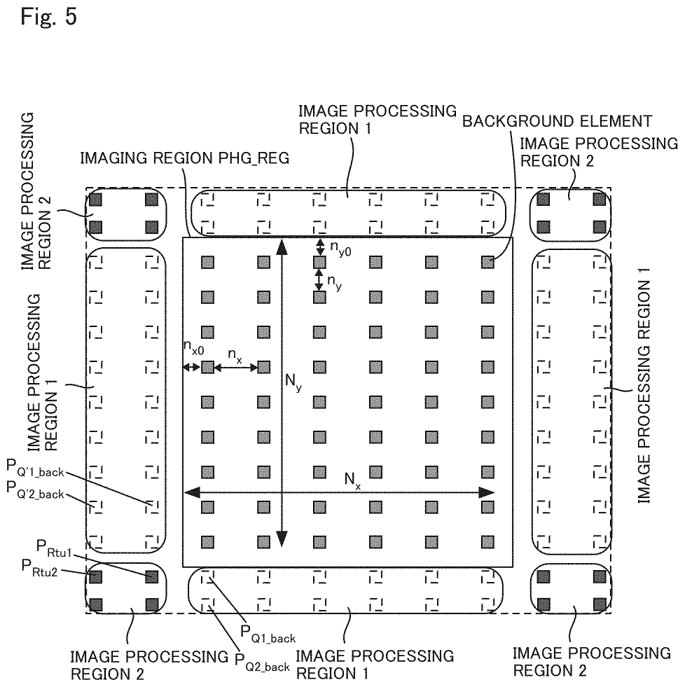

Described below is image processing performed by the calculator 5. FIG. 5 is a drawing illustrating how to process an image.

With reference to FIG. 5, image processing regions 1 and 2 are set outside the imaging region PHG_REG. The image processing regions 1 are arranged in the row and column directions of the imaging region PHG_REG. The image processing regions 2 are arranged on the extensions of the diagonals of the imaging region PHG_REG. In the imaging region PHG_REG, the background elements 32 alone are illustrated; whereas, the imaging elements 31 are arranged in a portion where the background elements 32 are not arranged.

Each of the image processing regions 1 above and below the imaging region PHG_REG includes k×Nₓ pixels (pixels illustrated by dotted tines) arranged in a k×Nₓ matrix. Moreover, each of the image processing regions 1 to the right and the left of the imaging region PHG_REG includes N_{y}×k pixels (pixels illustrated by dotted lines) arranged in an N_{y}×k matrix.

Each of the four image processing regions 2 includes k×k pixels arranged in a k×k matrix.

Processing Captured Image

In the captured image, a pixel not provided with an imaging element 31 (i.e. a pixel corresponding to a position of a background element 32) misses an image pixel value. Hence, in order to calculate all of the image pixel values in the imaging region PHG_REG, it is necessary to interpolate image pixel values of pixels corresponding to positions of background elements 32.

Described below is how to interpolate an image pixel value of a pixel included in the captured image and corresponding to a position of a background element 32.

The image pixel value of the pixel provided with the background element 32 is interpolated in accordance with image pixel values around the pixel of the background element 32.

For example, using an odd-number-dimensional average filter (F_{AVE}) having a weight of Expression 1 and image pixel values of surrounding pixels around a pixel corresponding to the background element 32, a convolution operation indicated by Expression 2 is performed to calculate an image pixel value corresponding to the position of the background element 32. That is, all of the image pixel values missing in the imaging region PHG_REG are interpolated, so that the captured image free from missing image pixel values can be calculated.

$$\begin{matrix}[ Math . 1 ] & \\ {F}_{AVE} = [ \begin{matrix}1 & 1 & 1 \\ 1 & 0 & 1 \\ 1 & 1 & 1\end{matrix} ] / 8 & ( 1 ) \\ [ Math . 2 ] & \\ {P}_{x , y}^{′} = {\sum }_{a = - c}^{c} {\sum }_{b = - c}^{c} ( {F}_{a , b} * {P}_{( x - a ) , ( y - b )} ) & ( 2 )\end{matrix}$$

If the image has a size of Nₓ×N_{y}, the pixel coordinates at the top-left end are (0, 0), the pixel coordinates at the top-right end are (Nₓ₋₁, 0), the pixel coordinates at the bottom-left end are (0, N_{y-1}), and the pixel coordinates at the bottom-right end are (Nₓ₋₁, N_{y-1}). That is, the value of a pixel having coordinates (x, y) is P_{x,y}, and a value of a pixel of at least a portion of the image is represented in a matrix as indicated by Expression (3). Hereinafter, the matrix is referred to as a pixel value matrix.

$$\begin{matrix}[ Math . 3 ] & \\ p = [ \begin{matrix}{P}_{x - 1 , y - 1} & {P}_{x - 1 , y} & {P}_{x - 1 , y + 1} \\ {P}_{x , y - 1} & {P}_{x , y} & {P}_{x , y + 1} \\ {P}_{x + 1 , y - 1} & {P}_{x + 1 , y} & {P}_{x + 1 , y + 1}\end{matrix} ] & ( 3 )\end{matrix}$$

Described next is an image processing filter having an order of “c”. The odd-number-dimensional image processing filter having the order of “c” is represented in a matrix of (2c+1)×(2c+1). Here, when the image processing filter is odd-number dimensional, indexes of the columns (rows) are −c, −c+1, . . . , −1, 0, 1, . . . , c−1, c.

An even-number-dimensional image processing filter having the order of “c” is represented in a matrix of 2c×2c. Here, when the image processing filter is even-number dimensional, indexes of the columns (rows) are −c+1, −c+2, . . . , 1, 0, 1, . . . , c−1, c.

An odd-number-dimensional image processing filter having an order of “c=1” is represented by Expression (4).

$$\begin{matrix}[ Math . 4 ] & \\ {F}_{odd ( 1 )} = [ \begin{matrix}{F}_{- 1 , - 1} & {F}_{- 1 , 0} & {F}_{- 1 , 1} \\ {F}_{0 , - 1} & {F}_{0 , 0} & {F}_{0 , 1} \\ {F}_{1 , - 1} & {F}_{1 , 0} & {F}_{1 , 1}\end{matrix} ] & ( 4 )\end{matrix}$$

An even-number-dimensional image processing filter having an order of “c=2” is represented by Expression (5).

$$\begin{matrix}[ Math . 5 ] & \\ {F}_{even ( 2 )} = [ \begin{matrix}{F}_{- 2 , - 2} & {F}_{- 2 , - 1} & {F}_{- 2 , 0} & {F}_{- 2 , 1} \\ {F}_{- 1 , - 2} & {F}_{- 1 , - 1} & {F}_{- 1 , 0} & {F}_{- 1 , 1} \\ {F}_{0 , - 2} & {F}_{- 1 , - 1} & {F}_{0 , 0} & {F}_{0 , 1} \\ {F}_{1 , - 2} & {F}_{1 , - 1} & {F}_{1 , 0} & {F}_{1 , 1}\end{matrix} ] & ( 5 )\end{matrix}$$

Each element F_{a, b} of the matrices is referred to as a weight parameter. Filter indexes a, b of the odd-number-dimensional image processing filter are −c, −c+1, . . . , −1, 0, 1, . . . , c−1, c. Filter indexes a, b of the even-number-dimensional image processing filter are −c+1, −c+2, . . . , −1, 0, 1, . . . , c−1, c.

Note that described here is a case where the horizontal and vertical orders “c” are matched. Alternatively, the orders “c” do not have to match. For example, the horizontal order may be “cₓ”, and the vertical order may be “c_{y}”, and the image processing filter may have a matrix of (2cₓ+1)×(2c_{y}+1) or of 2cₓ×2c_{y}.

Moreover, the filter to be used for the interpolation of an image pixel value does not have to be limited to the above average filter. The filter may include, for example, such an average filter as a Gaussian filter. Furthermore, the filter may be a blurring filter. In addition, the filter may be an image processing filter estimating a weight parameter on the basis of values of image pixels around the pixel of the background element 32.

In using the odd-number-dimensional image processing filter, a convolution operation is performed by Expression (2) to calculate a pixel value P′_{x,y} of a pixel having coordinates (x, y) That is, the odd-number-dimensional image processing filter acts on pixels within a range of plus or minus “c” around the pixel coordinates (x, y).

Meanwhile, in using the even-number-dimensional image processing filter, a convolution operation is performed by Expression (6) below.

$$\begin{matrix}[ Math . 6 ] & \\ {P}_{\hat{x} , \hat{y}}^{′} = {\sum }_{a = - c}^{c - 1} {\sum }_{b = - c}^{c - 1} ( {F}_{a , b} * {P}_{( floor ( \hat{x} ) - a ) , ( floor ( \hat{y} ) - b} ) & ( 6 )\end{matrix}$$

If, for resizing of the image, a pixel value of a pixel between two pixels has to be calculated, the even-number-dimensional image processing filter indicated by Expression (5) is used. Here, usually, pixel coordinates in an original image are converted into calculation pixel coordinates, and pixel coordinates between the calculation pixel coordinates are represented by coordinates having decimal points. That is, in resizing the background image, the pixel coordinates (x, y) are divided by an interval nₓ (or n_{y}) between the background pixel values, and the result is converted into calculation pixel coordinates (x\hat{ }, y\hat{ })=(x/nₓ, y/n_{y}), so that the interval between the pixel values in the background image is 1.

Using this coordinate system, a convolution operation is performed by Expression (6) with an even-number-dimensional image processing filter having the order of “c”. That is, the even-number-dimensional image processing filter acts on pixels having calculation pixel coordinates ranging (floor (x\hat{ })−c+1 to floor (x\hat{ })+c) and (floor (y\hat{ })−c+1 to floor(y\hat{ })+c). Here, the floor function is used to round down a non-integer value to an integer.

Finally, after the image processing, the calculation pixel coordinates (x\hat{ }, y\hat{ }) are converted into (back to) the pixel coordinates (x, y) of the original image.

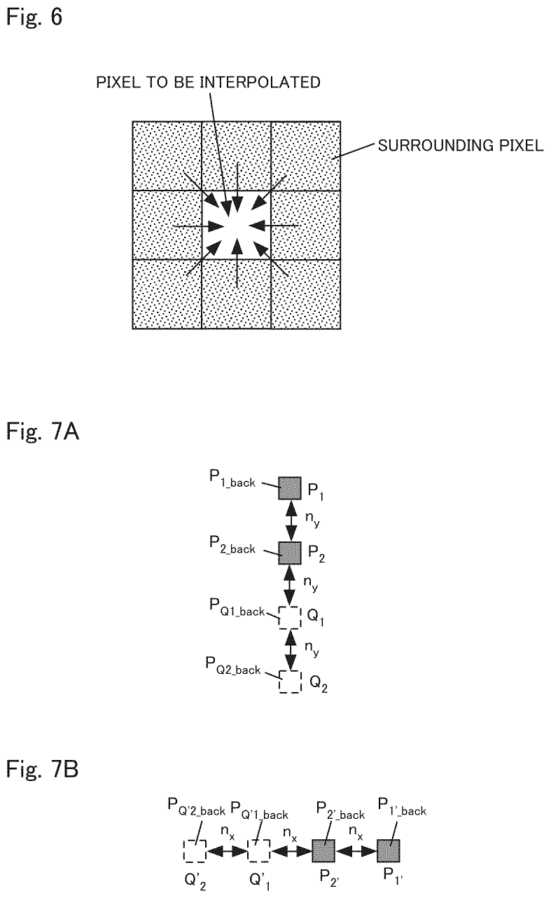

FIG. 6 is a conceptual illustration of how to interpolate an imaging pixel. With reference to FIG. 6, a pixel value of a pixel to be interpolated is obtained as follows. A convolution operation is performed on the surrounding pixels around the pixel to be interpolated by Expression (2) or Expression (6), using pixel values of the surrounding pixels and the image processing filter (an odd-number-dimensional image processing filter or an even-number-dimensional image processing filter). The pixel values of the surrounding pixels are averaged by the convolution operation, and interpolated as the pixel value of the pixel to be interpolated.

How to Process Background Image

In the background image, a pixel not provided with a background element 32 (i.e. a pixel corresponding to a position of an imaging element 31) misses a background pixel value. Hence, in order to calculate all of the background pixel values in the imaging region PHG_REG, it is necessary to interpolate background pixel values of pixels corresponding to positions of background elements 31. Described below is how to estimate a background pixel value of a pixel included in the background image and not provided with a background element 32 of the imaging region PHG_REG.

A process for estimating the background pixel value includes two processes: a preprocess estimating a background pixel value outside the imaging region PHG_REG (referred to as an image processing region); and a postprocess estimating a background pixel value corresponding to a position of an imaging element 31. The postprocess utilizes a background pixel value of an obtained background image and a background pixel value estimated in the preprocess.

### (1) Preprocess

As illustrated in FIG. 5, pixels are added to the image processing regions 1 and 2 outside the imaging region PHG_REG. Each of the image processing regions 1 above and below the imaging region PHG_REG includes k×Nx pixels (pixels illustrated by dotted lines) arranged in a k×Nx matrix. Moreover, each of the image processing regions 1 to the right and the left of the imaging region PHG_REG includes Ny×k pixels (pixels illustrated by dotted lines) arranged in an Ny×k matrix. Furthermore, each of the four image processing regions 2 includes k×k pixels arranged in a k×k matrix. As a result, with the imaging region PHG_REG and the image processing regions 1 and 2 put together, (floor((Nₓ−nₓ₀)/nₓ)+2k)×(floor((N_{y}−n_{y0})/n_{y})+2k) background pixels are arranged at pixel intervals corresponding to the intervals between the background elements 32 in the imaging region PHG_REG.

The background pixel values in the image processing regions 1 are calculated in a preprocess 1, and the background pixel values in the image processing regions 2 are calculated in a preprocess 2. Note that the value “k” needs to be either the same as, or larger than, the sum of the orders of a filter to be used for the postprocess.

### (1-1) Preprocess 1

A background pixel value Qₛ in each image processing region 1 is interpolated by, for example, a linear method indicated by Expression (7).

[Math. 7]

Qₛ=s*(P₂−P₁)+P₂ (7)

In Expression (7), a relationship of s=1 to k holds.

FIGS. 7A and 7B are drawings illustrating the preprocess 1. FIG. 7A shows the preprocess 1 with two background pixels outside the imaging region PHG_REG P_{Q1_back} and P_{Q2_back} in FIG. 5 as an example.

With reference to FIG. 7A, the background pixels P_{Q1_back} and P_{Q2_back} are arranged in the same column as that of background pixels P_{1_back} and P_{2_back} in the imaging region PHG_REG. The background pixel P_{2_back} is closest in the imaging region PHG_REG to the background pixels P_{Q1_back} and P_{Q2_back} whose background pixel values are to be calculated, and the background pixel P_{1_back} is second closest in the imaging region PHG_REG to the background pixels P_{Q1_back} and P_{Q2_back} whose background pixel values are to be calculated.

An interval between the background pixels P_{1_back} and P_{2_back}, an interval between the background pixels P_{2_back} and P_{Q1_back}, and an interval between the background pixels P_{Q1_back} and P_{Q2_back} are n_{y}.

Moreover, the background pixel value of the background pixel P_{1_back} is P₁, and the background pixel value of the background pixel P_{2_back} is P₂.

In calculating a background pixel value Q₁ of the background pixel P_{Q1_back}, a pixel interval (=n_{y}) between the background pixel P_{Q1_back} and the background pixel P_{2_back} closest to the background pixel P_{Q1_back} is divided by an interval (=n_{y}) of the background pixels in the column direction. The result of the division is s (=n_{y}/n_{y}=1).

The background pixel values P₁, P₂, and s (=1) are substituted for Expression (7), and the background pixel value Q1(=P₂−P₁+P₂) is calculated.

Moreover, in calculating a background pixel value Q₂ of the background pixel P_{Q2_back}, a pixel interval (=2×n_{y}) between the background pixel P_{Q2_back} and the background pixel P_{2_back} closest in the imaging region PHG_REG to the background pixel P_{Q2_back} is divided by the interval (=n_{y}) of the background pixels in the column direction. The result of the division is s (=2×n_{y}/n_{y}=2).

The background pixel values P₁, P2, and s (=2) are substituted for Expression (7), and the background pixel value Q₂ (=2×(P₂−P₁)+P₂) is calculated.

The value (P₂−P₁) is a difference between the background pixel value P₂ of the background pixel P_{2_back} and the background pixel value P₁ of the background pixel P_{1_back}. As a result, the background pixel value Q₁ (=P₂−P₁+P₂) is the background pixel value P₂ of the background pixel P_{2_back} altered by the difference (P₂−P₁). The background pixel value Q₂ (=2×(P₂−P₁)+P₂) is the background pixel value P₂ of the background pixel P_{2_back} altered by the difference 2×(P₂−P₁).

Hence, when a pixel interval to the background pixel P_{2_back} is large (i.e. 2×n_{y}), the background pixel value Q₂ (=2×(P₂−P₁)+P₂) is calculated so that the difference in pixel value from the background pixel value P₂ becomes large (that is, the difference is 2×(P₂−P₁)). When a pixel interval to the background pixel P_{2_back} is small n_{y}), the background pixel value Q₁ (=(P₂−P₁)+P₂) is calculated so that the difference in pixel value from the background pixel value P₂ becomes small (that is, the difference is (P₂−P₁)).

FIG. 7B shows the preprocess 1 with two background pixels outside the imaging region PHG_REG P_{Q′1_back} and P_{Q′2_back} in FIG. 5 as an example.

With reference to FIG. 7B, the background pixels P_{Q′_back} and P_{Q′2_back} are arranged in the same row as that of background pixels P_{1′_back} and P_{2′_back} in the imaging region PHG_REG. The background pixel P_{2′_back} is closest in the imaging region PHG_REG to the background pixels P_{Q′1_back} and P_{Q′2_back} whose background pixel values are to be calculated, and the background pixel P_{1′_back} is second closest in the imaging region PHG_REG to the background pixels P_{Q′1_back} and P_{Q′2_back} whose background pixel values are to be calculated.

An interval between the background pixels P_{1′_back} and P_{2′_back}, an interval between the background pixels P_{2′_back} and P_{Q′1_back}, and an interval between the background pixels P_{Q′1_back} and P_{Q′2_back} are nₓ.

Moreover, the background pixel value of the background pixel P_{1′_back} is P_{1′}, and the background pixel value of the background pixel P_{2′_back} is P_{2′},

In calculating a background pixel value Q′₁ of the background pixel P_{Q′1_back}, a pixel interval (=nₓ) between the background pixel P_{Q′1_back} and the background pixel P_{2′_back} closest to the background pixel P_{Q′1_back} is divided by a pixel interval (=nₓ) of the background pixels in the row direction. The result of the division is s (=nₓ/nₓ=1).

The background pixel values P_{1′}, P_{2′}, and s (=1) are substituted for Expression (7), and the background pixel value Q′₁ (=P_{2′}−P₁+P_{2′}) is calculated.

In calculating a background pixel value Q′₂ of the background pixel P_{Q′2_back}, a pixel interval (=2×nₓ) between the background pixel P_{Q′2_back} and the background pixel P_{2′_back} closest in the imaging region PHG_REG to the background pixel P_{Q′2_back} is divided by a pixel interval (=nₓ) of the background pixels in the row direction. The result of the division is s (=2×nₓ/nₓ=2).

The background pixel values P_{1′}, P_{2′}, and s (=2) are substituted for Expression (7), and the background pixel value Q′₂ (=2(P_{2′}−P_{1′})+P_{2′}) is calculated.

The value (P_{2′}−P_{1′}) is a difference between the background pixel value P_{2′} of the background pixel P_{2′_back} and the background pixel value P_{1′} of the background pixel P_{1′_back}. As a result, the background pixel value Q′₁ (=P_{2′}−P_{1′}+P_{2′}) is the background pixel value P_{2′} of the background pixel P_{2′_back} altered by the difference (P_{2′}−P_{1′}). The background pixel value Q′₂ (=2×(P_{2′}−P_{1′})+P_{2′}) is the background pixel value P_{2′} of the background pixel P_{2′_back} altered by the difference 2×(P_{2′}−P_{1′}).

Hence, when a pixel interval to the background pixel P_{2′_back} is large (i.e. 2×nₓ), the background pixel value Q′₂ (=2×(P_{2′}−P_{1′})+P_{2′}) is calculated so that the difference in pixel value from the background pixel value P_{2′} becomes large (that is, the difference is 2(P_{2′}−P_{1′})). When an interval to the background pixel P_{2′_back} is small (i.e. nₓ), the background pixel value Q′₁ (=(P_{2′}−P_{1′})+P_{2′}) is calculated so that the difference in pixel value from the background pixel value P_{2′} becomes small (that is, the difference is (P_{2′}−P_{1′})).

As to the image processing regions 1 above and below the imaging region PHG_REG, the background pixel values of all the background pixels in the image processing regions 1 are calculated by the method shown in FIG. 7A. As to the image processing regions 1 to the right and the left of the imaging region PHG_REG, the background pixel values of all the background pixels in the image processing regions 1 are calculated by the method shown in FIG. 7B.

Note that the method for interpolating the background pixel values performed in the preprocess 1 shall not be limited to the one shown by Expression (7). The values may be estimated, taking into consideration alteration in a secondary (or a higher) order of background pixel values in the imaging region PHG_REG.

### (1-2) Preprocess 2

Described below is how to calculate a background pixel value in each image processing region 2. A background pixel value in the image processing region 2 is interpolated by, for example, a linear method indicated by Expression (8).

$$\begin{matrix}[ Math . 8 ] & \\ & ( 8 ) \\ {R}_{tu} = \frac{( {R}_{t} + {R}_{u} )}{2} & ( 8 a ) \\ {R}_{t} = t * ( {Q}_{2} - {Q}_{1} ) + {Q}_{2} & ( 8 b ) \\ {R}_{u} = u * ( {Q}_{b} - {Q}_{a} ) + {Q}_{a} & ( 8 c )\end{matrix}$$

In Expression (8), “t” and “u” respectively satisfy t=1 to k and u=1 to k.

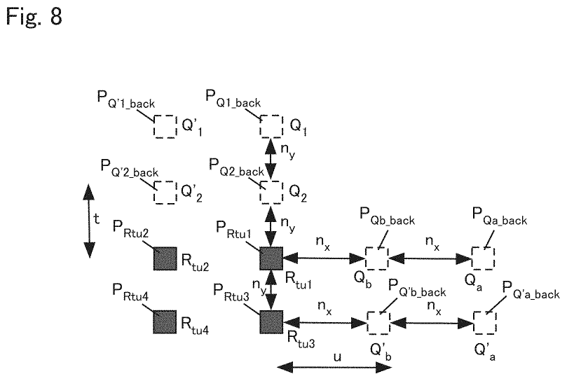

FIG. 8 is a drawing illustrating the preprocess 2. FIG. 8 shows the preprocess 2 with two background pixels in the image processing regions 2 P_{Rtu1} and P_{Rtu2} in FIG. 5 as an example.

With reference to FIG. 8, the background pixel P_{Rtu1} is disposed in the same column as that of the background pixels P_{Q1_back} and P_{Q2_back} in the imaging processing regions 1, and in the same row as that of the background pixels P_{Qb_back} and P_{Qa_back} in the image processing regions 1. The background pixels P_{Q2_back} and P_{Qb_back} are closest in the image processing regions 1 to the background pixel P_{Rtu1} whose background pixel value is to be calculated. The background pixels P_{Q1_back} and P_{Qa_back} are second closest in the image processing regions 1 to the background pixel P_{Rtu1} whose background pixel is to be calculated.

A pixel interval between the background pixels P_{Q1_back} and P_{Q2_back}, and a pixel interval between the background pixels P_{Q2_back} and P_{Rtu1} are n_{y}. A pixel interval between the background pixels P_{Qa_back} and P_{Qb_back}, and a pixel interval between the background pixels P_{Qb_back} and P_{Rtu1} are nₓ.

Moreover, a background pixel value of the background pixel P_{Q1_back} is Q₁, and a background pixel value of the background pixel P_{Q2_back} is Q₂.

Furthermore, a background pixel value of the background pixel P_{Qa_back} is Qₐ, and a background pixel value of the background pixel P_{Qb_back} is Q_{b}.

In calculating a background pixel value Rₜᵤ₁ of the background pixel P_{Rtu1}, a pixel interval (=nₓ) between the background pixel P_{Rtu1} and the background pixel P_{Qb_back} closest in the image processing regions 1 to the background pixel P_{Rtu1} is divided by an interval (=nₓ) of the background pixels in the row direction. The result of the division is u (=nₓ/nₓ=1).

The background pixel values Qₐ, Q_{b}, and u (=1) are substituted for Expression (8c), and a background pixel value Qᵤ₁ (=Q_{b}−Qₐ+Q_{b}) is calculated.

Furthermore, a pixel interval (=n_{y}) between the background pixel P_{Rtu1} and the background pixel P_{Q2_back} closest in the image processing regions 1 to the background pixel P_{Rtu1} is divided by an interval (=n_{y}) of the background pixels in the column direction. The result of the division is t (=n_{y}/n_{y}=1).

The background pixel values Q₁, Q₂ and t (=1) are substituted for Expression (8b), and a background pixel value Qₜ₁ (=Q₂−Q₁+Q₂) is calculated.

After that, the background pixel values Qᵤ₁ (=Q_{b}−Qₐ+Q_{b}) and Qₜ₁ (=Q₂−Q₁+Q₂) are substituted for Expression (8a), and the background pixel value Rₜᵤ₁ is calculated. Hence, the background pixel value Rₜᵤ₁ is calculated as an average of the background pixel values Qᵤ₁ and Qₜ₁. Qᵤ₁ is calculated from the background pixel values Qₐ and Q_{b} in the row direction, and Qₜ₁ is calculated from the background pixel values Q₁ and Q₂ in the column direction.

The background pixel P_{Rtu2} is disposed in the same column as that of the background pixels P_{Q′1_back} and P_{Q′2_back} in the imaging processing regions 1, and in the same row as that of the background pixels P_{Qb_back} and P_{Qa_back} in the image processing regions 1.

The background pixels P_{Q′2_back} and P_{Qb_back} are closest in the image processing regions 1 to the background pixel P_{Rtu2} to be calculated. The background pixels P_{Q′1_back} and P_{Qa_back} are second closest in the image processing regions 1 to the background pixel P_{Rtu2} to be calculated.

A pixel interval between the background pixels P_{Q′1_back} and P_{Q′2_back}, and a pixel interval between the background pixels P_{Q′2_back} and P_{Rtu2} are n_{y}. A pixel interval between the background pixels P_{Qa_back} and P_{Qb_back}, a pixel interval between the background pixels P_{Qb_back} and P_{Rtu1}, and a pixel interval between the background pixels P_{Rtu1} and P_{Rtu2} are nₓ.

Moreover, the background pixel value of the background pixel P_{Q′1_back} is Q′₁, and the background pixel value of the background pixel P_{Q′2_back} is Q′₂.

In calculating a background pixel value Rₜᵤ₂ of the background pixel P_{Rtu2}, a pixel interval (=2×nₓ) between the background pixel P_{Rtu2} and the background pixel P_{Qb_back} closest in the image processing regions 1 to the background pixel P_{Rtu2} is divided by a pixel interval (=nₓ) of the background pixels in the row direction. The result of the division is u (=2×nₓ/nₓ=2).

The background pixel values Qₐ, Qb, and u (=2) are substituted for Expression (8c), and a background pixel value Qᵤ₂ (=2×(Q_{b}−Qₐ)+Q_{b}) is calculated.

Furthermore, a pixel interval (=n_{y}) between the background pixel P_{Rtu2} and the background pixel P_{Q′2_back} closest in the image processing regions 1 to the background pixel P_{Rtu2} is divided by a pixel interval (=n_{y}) of the background pixels in the column direction. The result of the division is t (=n_{y}/n_{y}=1).

The background pixel values Q′1, Q′2, and t (=1) are substituted for Expression (8b), and a background pixel value Qₜ₂(=Q′2−Q′1+Q′2) is calculated.

After that, the background pixel values Qᵤ₂ (=2×(Q_{b}−Qₐ)+Q_{b}) and Qₜ₂ (=Q′2−Q′1+Q′2) are substituted for Expression (8a) and the background pixel value Rₜᵤ₂ is calculated. Hence, the background pixel value Rₜᵤ₂ is calculated as an average of background pixel values Qᵤ and Qₜ, Qᵤ is calculated from the background pixel values Qₐ and Q_{b} in the row direction, and Qₜ is calculated from the background pixel values Q′₁ and Q′₂ in the column direction.

A background pixel P_{Rtu3} is disposed in the same column as that of the background pixels P_{Q1_back} and P_{Q2_back} in the imaging processing regions 1, and in the same row as that of the background pixels P_{Q′b_back} and P_{Q′a_back} in the image processing regions 1. The background pixels P_{Q2_back} and P_{Q′b_back} are closest in the image processing regions 1 to the background pixel P_{Rtu3} to be calculated. The background pixels P_{Q1_back} and P_{Q′a_back} are second closest in the image processing regions 1 to the background pixel P_{Rtu3} to be calculated.

A pixel interval between the background pixels P_{Q1_back} and P_{Q2_back}, and a pixel interval between the background pixels P_{Q2_back} and P_{Rtu3} are n_{y}. Furthermore, a pixel interval between the background pixels P_{Q′a_back} and P_{Q′b_back}, and a pixel interval between the background pixels P_{Q′b_back} and P_{Rtu3} are nₓ.

Moreover, the background pixel value of the background pixel P_{Q1_back} is Q₁, and the background pixel value of the background pixel P_{Q2_back} is Q₂.

In addition, the background pixel value of the background pix P_{Q′a_back} is Q′ₐ, and the background pixel value of the background pixel P_{Q′b_back} is Q′_{b}.

In calculating a background pixel value Rₜᵤ₃ of the background pixel P_{Rtu3}, an interval (=nₓ) between the background pixel P_{Rtu3} and the background pixel P_{Q′b_back} closest in the image processing regions 1 to the background pixel P_{Rtu3} is divided by an interval (=nₓ) of the background pixels in the row direction. The result of the division is u(=nₓ/nₓ=1).

The background pixel values Q′ₐ, Q′_{b}, and u (=1) are substituted for Expression (8c), and a background pixel value Qᵤ₃ (=Q′_{b}−Q′ₐ+Q′_{b}) is calculated.

Furthermore, a pixel interval (=2×n_{y}) between the background pixel P_{Rtu3} and the background pixel P_{Q2_back} closest in the image processing regions 1 to the background pixel P_{Rtu3} is divided by a pixel interval (=n_{y}) of the background pixels in the column direction. The result of the division is t (=2×n_{y}/n_{y}=2).

The background pixel values Q₁, Q₂ and t (=2) are substituted for Expression (8b), and a background pixel value Qₜ₃ (=2×(Q₂−Q₁)+Q₂) is calculated.

After that, the background pixel values Qᵤ₃ (=Q′_{b}−Q′ₐ+Q′_{b}) and Qₜ₃ (=2×(Q₂−Q₁)+Q₂) are substituted for Expression (8a), and the background pixel value Rₜᵤ₃ is calculated. Hence, the background pixel value Rₜᵤ₃ is calculated as an average of the background pixel values Qᵤ₃ and Qₜ₄. Qᵤ₃ is calculated from the background pixel values Q′ₐ and Q′_{b} in the row direction, and Qₜ₄ is calculated from the background pixel Q₁ and Q₂ in the column direction.

A background pixel P_{Rtu4} is disposed in the same column as that of the background pixels P_{Q′1_back} and P_{Q′2_back} in the imaging processing regions 1, and in the same row as that of the background pixels P_{Q′b_back} and P_{Q′a_back} in the image processing regions 1.

The background pixels P_{Q′2_back} and P_{Q′b_back} are closest in the image processing regions 1 to the background pixel P_{Rtu4} to be calculated. The background pixels P_{Q′1_back} and P_{Q′a_back} are second closest in the image processing regions 1 to the background pixel P_{Rtu4} to be calculated.

A pixel interval between the background pixels P_{Q′1_back} and P_{Q′2_back} is n_{y}, and a pixel interval between the background pixels P_{Q′2_back} and P_{Rtu4} is 2×n_{y}. Furthermore, a pixel interval between the background pixels P_{Q′a_back} and P_{Q′b_back}, a pixel interval between the background pixels P_{Q′b_back} and P_{Rtu3}, and a pixel interval between the background pixels between P_{Rtu3} and P_{Rtu4} are nₓ.

Moreover, the background pixel value of the background pixel P_{Q′1_back} is Q′₁, the background pixel value of the background pixel P_{Q′2_back} is Q′₂, the background pixel value of the background pixel P_{Q′a_back} is Q′ₐ, and the background pixel value of the background pixel P_{Q′b_back} is Q′_{b}.

In calculating a background pixel value Rₜᵤ₄ of the background pixel P_{Rtu4}, a pixel interval (=2×nₓ) between the background pixel P_{Rtu4} and the background pixel P_{Q′b_back} closest in the image processing regions 1 to the background pixel P_{Rtu4} is divided by an interval (=nₓ) of the background pixels in the row direction. The result of the division u (=2×nₓ/nₓ=2).

The background pixel values Q′ₐ, Q′_{b}, and u (=2) are substituted for Expression (8c), and a background pixel value Qᵤ₄ (=2×(Q′_{b}−Q′ₐ)+Q′_{b}) is calculated.

Furthermore, a pixel interval (=2×n_{y}) between the background pixel P_{Rtu4} and the background pixel P_{Q′2_back} closest in the image processing regions 1 to the background pixel P_{Rtu4} is divided by a pixel interval (=n_{y}) of the background pixels in the column direction. The result of the division is t (=2×n_{y}/n_{y}=2).

The background pixel values Q′₁, Q′₂, and t (=2) are substituted for Expression (8b), and a background pixel value Qₜ₄ (=2×(Q′₂−Q′₁)+Q′₂) is calculated.

After that, the background pixel values Qᵤ₄ (=2×(Q′_{b}−Q′ₐ)+Q′_{b}) and Qₜ₄ (=2×(Q′₂−Q′₁)+Q′₂) are substituted for Expression (8a), and the background pixel value Rₜᵤ₄ is calculated. Hence, the background pixel value Rₜᵤ₄ is calculated as an average of the background pixel values Qᵤ₄ and Qₜ₄. Qᵤ₄ is calculated from the background pixel values Q′ₐ and Q′_{b} in the row direction, and Qₜ₄ calculated from the background pixel values Q′₁ and Q′₂ in the column direction.

Using the method illustrated in FIG. 8, background pixel values are calculated for all the background pixels in the four image processing regions 2 illustrated in FIG. 5.

As described above, the background pixel value Rₜᵤ₁ of the background pixel P_{Rtu1} is calculated as an average of the background pixel values Qᵤ₁ (=Q_{b}−Qₐ+Q_{b}) and Qₜ₁ (=Q₂−Q₁+Q₂). The background pixel value Rₜᵤ₂ of the background pixel P_{Rtu2} is calculated as an average of the background pixel values Qᵤ₂ (=2×(Q_{b}−Qₐ)+Q_{b}) and Qₜ₂ (=Q′₂−Q′₁+Q′₂). The background pixel value Rₜᵤ₃ of the background pixel P_{Rtu3} is calculated as an average of the background pixel values Qᵤ₃ (=Q′_{b}−Q′ₐ+Q′_{b}) and Qₜ₃ (=2×(Q₂−Q₁)+Q₂). The background pixel value Rₜᵤ₄ of the background pixel P_{Rtu4} is calculated as an average of the background pixel values Qᵤ₄ (=2×(Q′_{b}−Q′ₐ)+Q′_{b}) and Qₜ₄ (=2×(Q′₂−Q′₁)+Q′₂).

The background pixel value Qᵤ₁ (=Q_{b}−Qₐ+Q_{b}) is the background pixel value Q_{b} altered by a difference (=Q_{b}−Qₐ). The background pixel value Qᵤ₂ (=2×(Q_{b}−Qₐ)+Q_{b}) is the background pixel value Q_{b} altered by a difference (=2×(Q_{b}−Qₐ)). The background pixel value Qᵤ₃ (=Q′_{b}−Q′ₐ+Q′_{b}) is the background pixel value Q′_{b} altered by a difference (=Q′_{b}−Q′ₐ). The background pixel value Qₜ₃ (=2×(Q₂−Q₁)+Q₂) is the background pixel value Q₂ altered by a difference (=Q₂−Q₁). The background pixel value Qᵤ₄ (=2×(Q′_{b}−Q′ₐ)+Q′_{b}) is the background pixel value Q′_{b} altered by a difference (=2×(Q′_{b}−Q′ₐ)). The background pixel value Qₜ₄ (=2×(Q′₂−Q′₁)+Q′₂) is the background pixel value Q′₂ altered by a difference (=2×(Q′₂−Q′₁)).

Hence, if a pixel interval of pixels between each of the background pixels P_{Rtu1} to P_{Rtu4} and the background pixel (any one of the background pixels P_{Q2_back}, P_{Q′2_back}, P_{Qb_back}, and P_{Q′b_back}) closest in the image processing regions 1 to the background pixels P_{Rtu1} to P_{Rtu4} becomes larger (that is, 2×nₓ), the background pixel values Rₜᵤ₁ to Rₜᵤ₄ in the image processing regions 2 calculate the background pixel values Qᵤ₂ and Qᵤ₄ so that a difference in pixel value from the background pixel value (any one of the background pixel values Q₂, Q′₂, Q_{b}, and Q′_{b}) becomes larger. If the pixel interval of the pixels between each of the background pixels P_{Rtu1} to P_{Rtu4} and the background pixel (any one of the background pixels P_{Q2_back}, P_{Q′2_back}, P_{Qb_back}, and P_{Q′b_back}) closest in the image processing regions 1 to the background pixels P_{Rtu1} to P_{Rtu4} becomes smaller (that is, nₓ), the background pixel values Rₜᵤ₁ to Rₜᵤ₄ in the image processing regions 2 calculate the background pixel values Qᵤ₁ and Qᵤ₃ so that a difference in pixel value from the background pixel value (any one of the background pixel values Q₂, Q′₂, Q_{b}, and Q′_{b}) becomes smaller.

Moreover, if an interval of pixels between each of the background pixels P_{Rtu1} to P_{Rtu4} and the background pixel (any one of the background pixels P_{Q2_back}, P_{Q′2_back}, P_{Qb_back}, and P_{Q′b_back}) closest in the image processing regions 1 to the background pixels P_{Rtu1} to P_{Rtu4} becomes larger (that is, 2×n_{y}), the background pixel values Rₜᵤ₁ to Rₜᵤ₄ calculate the background pixel values Qₜ₃ and Qₜ₄ so that a difference in pixel value from the background pixel value (any one of the background pixel values Q2, Q′2, Qb, and Q′b) becomes larger. If the interval of the pixels between each of the background pixels P_{Rtu1} to P_{Rtuc4} and the background pixel (any one of the background pixels P_{Q2_back}, P_{Q′2_bck}, P_{Qb_back}, and P_{Q′b_back}) closest in the image processing regions 1 to the background pixels P_{Rtu1} to P_{Rtu4} becomes smaller (that is, n_{y}), the background pixel values Rₜᵤ₁ to Rₜᵤ₄ calculate the background pixel values Qₜ₁ and Qₜ₂ so that a difference in pixel value from the background pixel value (any one of the background pixel values Q₂, Q′₂, Q_{b}, and Q′_{b}) becomes smaller.

Furthermore, the method for interpolating the background pixel values performed in the preprocess 2 shall not be limited to the one shown by Expression (8). The values may be estimated, taking into consideration a secondary (or a higher) variation in the background pixel values in the image processing regions 1.

Image Denoising

Described next is denoising. Prior to image resizing to be described later, the background pixel values of the imaging region PHG_REG and the image processing regions 1 and 2 may be denoised.

For example, the background pixel values can be denoised with an average filter indicated by Expression (9).

$$\begin{matrix}[ Math . 9 ] & \\ {F}_{noise \_ cancel} = [ \begin{matrix}1 & 1 & 1 \\ 1 & 1 & 1 \\ 1 & 1 & 1\end{matrix} ] / 9 & ( 9 )\end{matrix}$$

As a precondition, a background image before resizing includes background pixel values having pixel coordinates (x, y) of the original image and entered at equal intervals nₓ (or n_{y}). Hence, as seen in the resizing, the pixel coordinates are converted into calculation pixel coordinates (x\hat{ }, y\hat{ }). After that, the denoising filter is applied. The denoising filter has an order of c_n.

The denoising is performed as follows. First, pixel coordinates (x, y) of the original image are converted into calculation pixel coordinates (x\hat{ }, y\hat{ }).

Next, using a background pixel value having the calculation pixel coordinates (x\hat{ }, y\hat{ }) and a denoising filter (e.g. the average filter of Expression (9)), a convolution operation is performed with, for example, Expression (2) described above. Hence, a background pixel value (x\hat{ }, y\hat{ }) processed with the denoising filter can be calculated.

Finally, the calculation pixel coordinates (x\hat{ }, y\hat{ }) are converted into (back to) the pixel coordinates (x, y) of the original image. Such processing makes it possible to calculate a denoised background pixel value (x, y).

Image Resizing

Finally described is how to estimate a background pixel value in the imaging region (Nₓ×N_{y} pixels). Resizing is performed for calculating a background pixel value in a position corresponding to an imaging element 31, using background pixel values of a background image in the imaging region PHG_REG and in the image processing regions 1 and 2.

Here, the resizing filter has an order of c_re. For example, the above resizing can be performed with a Lanczos(c_e) filter having the order of c_re and indicated by Expression (10).

$$\begin{matrix} [ Math . 10 ] & \\ & ( 10 ) \\ {{F}_{Lanczos} ( c\_re )}_{\hat{x} - floor ( \hat{x} ) + a , \hat{y} - floor ( \hat{y} ) + b} = f ( \hat{x} - floor ( \hat{x} ) + a ) * f ( \hat{y} - floor ( \hat{y} ) + b ) & ( 10 a ) \\ f ( x ) = sin c ( x ) * sin c ( x / c\_re ) & ( 10 b )\end{matrix}$$

The resizing is described, using an even-number-dimensional Lanczos filter having the order of c_re. Pixel values having pixel coordinates (x, y) in a background image are entered at equal intervals nₓ (or n_{y}). As a preparation for a convolution operation, the pixel coordinates (x, y) are divided by nₓ and n_{y} and the result is converted into calculation pixel coordinates (x\hat{ }, y\hat{ })=(x/nₓ, y/n_{y}), so that the interval between the values of the pixels in the background image is 1.

The resizing filter is for estimating a pixel value in a position of the calculation pixel coordinates (x\hat{ }, y\hat{ }). As represented by Expression (5), the resizing filter to be used is usually an even-number-dimensional image processing filter.

In the case of the Lanczos(c_re) filter, the filter is represented by Expression (10). Here, values “a” and “b” are matrix indexes, and range from −c_re to c_re−1.

A pixel value (x, y) of the background image is calculated in a sequence below.

First, pixel coordinates (x, y) of the background image are converted into calculation pixel coordinates (x\hat{ }, y\hat{ }).

Next, on the basis of the order c_re of the image processing filter and the calculation pixel coordinates (x\hat{ }, y\hat{ }), a weight parameter (e.g. Expression (10)) of the image processing filter is calculated.

After that, using the image processing filter and the calculation pixel coordinates (x\hat{ }, y\hat{ }), a convolution operation is performed to calculate a background pixel value having the calculation pixel coordinates (x\hat{ }, y\hat{ }).

Finally, the calculation pixel coordinates (x\hat{ }, y\hat{ }) are converted into (back to) the pixel coordinates (x, y) of the original image. Such processing makes it possible to calculate a resized background pixel value (x, y).

Note that the technique to perform the resizing is not limited to the above one using the Lanczos filter. The technique may include, for example, the k-nearest neighbor interpolation, and the bilinear interpolation. Furthermore, the resizing filter is not limited to the Lanczos filter. Alternatively, the resizing filter may be a sine function or a combination of a sine function and a window function.

In executing the above postprocess, the value “k” needs to be set larger than the sum of the orders of the filters. This is because application of each of the filters causes a reduction in image region to be accurately calculated in accordance with the orders of the filters. That is, when no denoising is performed, a relationship of c_re≤k needs to be satisfied. Moreover, where the order of the denoising is c_n, a relationship of c_re+c_n≤k needs to be satisfied when the denoising is performed.

How to Calculate Foreground Image

Described below is how to calculate a foreground image. The foreground image can be calculated when, for example, a background image is subtracted from a captured image. In the calculation, correction may be made, taking into consideration a difference between detection wavelengths of the imaging element 31 and the background element 32. For example, the foreground image can be obtained by calculation of a captured image—a background image an offset value. Moreover, the foreground image may be obtained also by a calculation of a correction coefficient×(a captured image−a background image)−an offset value, a captured image−a correction coefficient×a background image−an offset value, or a correction coefficient×(a captured image−a background image−an offset value).

Furthermore, other than the detection wavelengths of the imaging element 31 and the background element 32, the correction may be performed, taking into consideration a difference in intensity (that is a temperature of a surrounding Object) between infrared light incident on the elements. For this correction, items to be prepared include a thermometer to measure a temperature inside the infrared camera and a calibration table 1 for the temperatures and the offset values.

Moreover, a temperature distribution of the detector array 3 may be calculated from the background image, and the correction may be made on the basis of the temperature distribution. For this correction, items to be prepared include a temperature table to convert a background pixel value into an element temperature and a calibration table 2 to convert the element temperature into an offset value of the captured image.

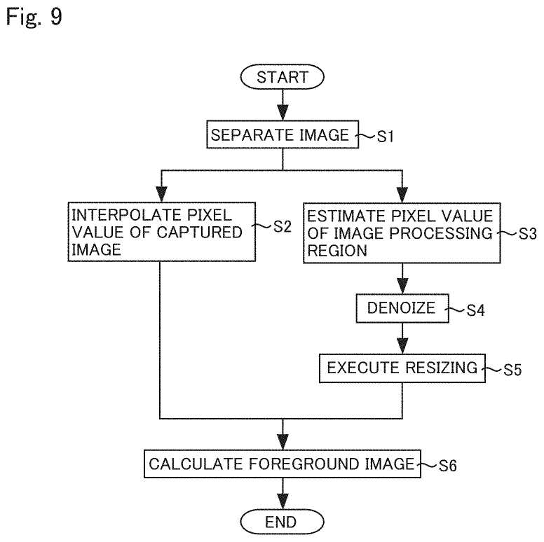

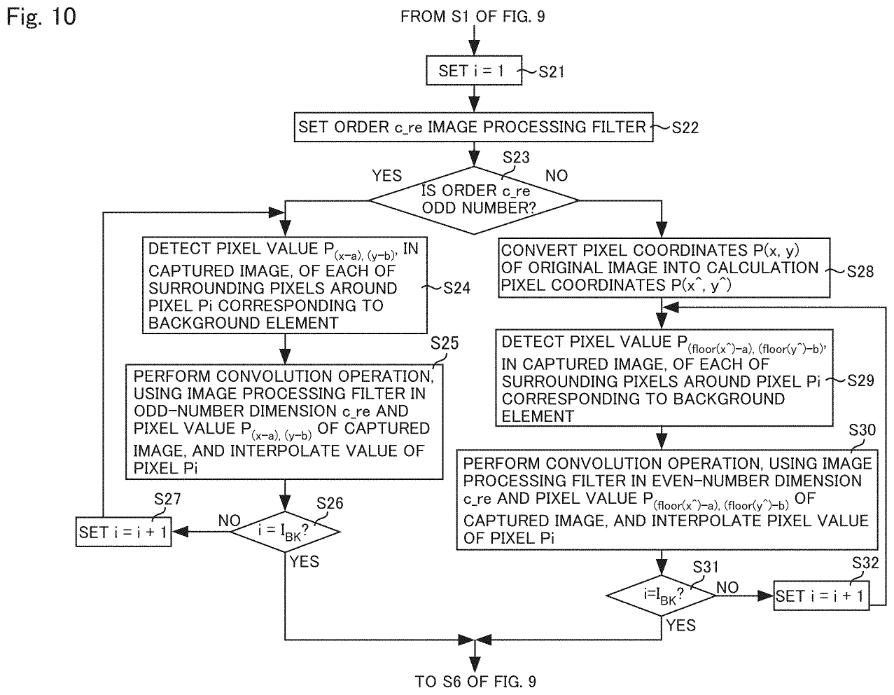

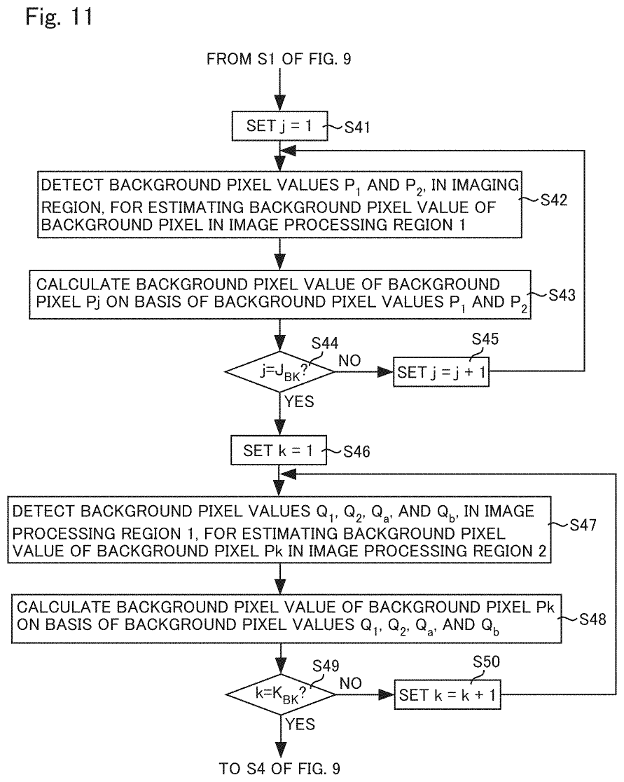

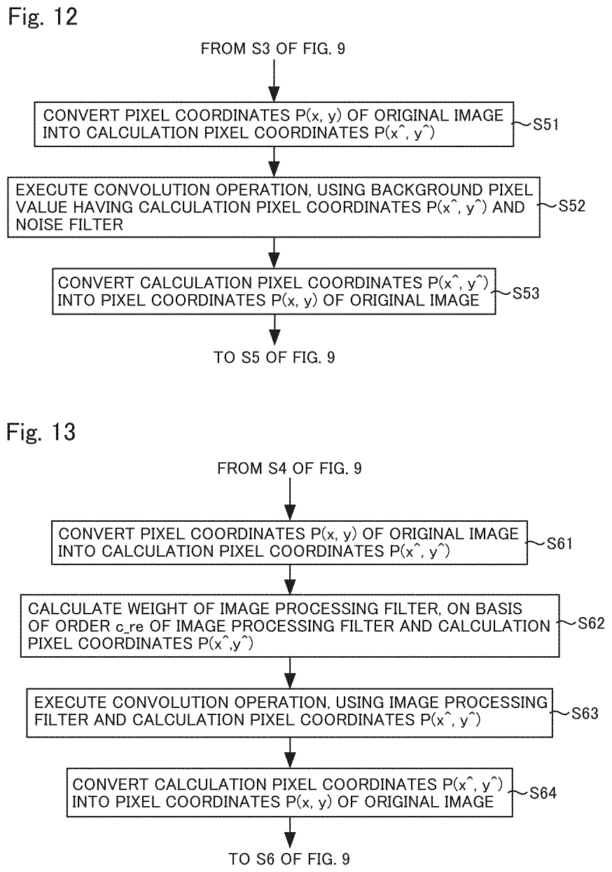

FIG. 9 is a flowchart showing how to calculate a foreground image. With reference to FIG. 9, an operation to calculate a foreground image starts at Step S1. The calculator 5 receives from the controller 4 the detection values D1 of the imaging elements 31 and the detection values D2 of the background elements 32, and separates an image into an image of the detection values D1 from the imaging elements 31 and an image of the detection values D2 from the background elements 32.

At Step S2, the calculator 5 interpolates a pixel value of a pixel corresponding to the background element 32, using a pixel value of a captured image, and, after that, calculates pixel values of the captured image in all the image region.

Meanwhile, after Step S1, the calculator 5 sequentially executes Steps S3 to S5 in parallel with Step S2. That is, at Step S3, the calculator 5 estimates pixel values of the image processing regions 1 and 2. At Step S4, the calculator 5 denoizes the pixel values. At Step S5, the calculator 5 executes resizing.

After Steps S2 and S5, at Step S6, the calculator 5 subtracts a pixel value of the background image from a pixel value of the captured image to calculate the foreground image. Hence, the operation to calculate the foreground image ends.

Note that, in the flowchart illustrated in FIG. 9, Step S4 may be omitted, and Step S5 may be executed after Step S3.

FIG. 10 is a flowchart showing specific operations at Step S2 in FIG. 9. With reference to FIG. 10, after Step S1 of FIG. 9, the calculator 5 sets i=1 at Step S21. At Step S22, the calculator 5 sets the order c_re for the image processing filter.

At Step S23, the calculator 5 determines whether the order c_re is an odd number.

At Step S23, if the calculator 5 determines that the order c_re is an odd number, the calculator 5 detects at Step S24 a pixel value P_{(x-a), (y-b)}, in the captured image, of each of the surrounding pixels around a pixel Pi corresponding to the background element 32 in the imaging region PHG_REG.

At Step S25, the calculator 5 performs a convolution operation by Expression (2), using the image processing filter in the odd-number dimension c_re and the pixel value P_{(x-a), (y-b)} of the captured image, and interpolates a value of the pixel Pi.

At Step S26, the calculator 5 determines whether i=I_{BK} holds. Here, I_{BK} is the total number of pixels Pi corresponding to the background elements 32 in the imaging region PHG_REG.

If the calculator determines at Step S26 that i=I_{BK} does not hold, the calculator 5 sets i=i+1 at Step S27. After that, a series of the operations proceeds to Step S24. Steps S24 to S27 are repeated until the calculator 5 determines at Step S26 that i=I_{BK} holds. After that, when the calculator 5 determines that i=I_{BK} holds at Step S26, the series of operations proceeds to Step S6 of FIG. 9.

Meanwhile, if the calculator 5 determines at Step S23 that the order c_re is not an odd number, the calculator 5 converts at Step S28 pixel coordinates P(x, y) of the original image into calculation pixel coordinates P(x\hat{ }, y\hat{ }).

At Step S29, the calculator 5 detects a pixel value P_{(floor(x\hat{ })-a), (floor(y\hat{ })-b)}, in the captured image, of each of the surrounding pixels around the pixel Pi corresponding to the background element 32 in the imaging region PHG_REG.

At Step S30, the calculator 5 performs a convolution operation by Expression (6), using the image processing filter in an even-number dimension c_re and the pixel value P_{(floor(x\hat{ })-a), (floor(y\hat{ })-b)} of the captured image, and interpolates a pixel value of the pixel Pi.

At Step S31, the calculator 5 determines whether i=I_{BK} holds. If the calculator 5 determines at Step S31 that i=I_{BK} does not hold, the calculator 5 sets i=i+1 at Step S32. After that, a series of the operations proceeds to Step S29. Steps S29 to S32 are repeated until the calculator 5 determines at Step S31 that i=I_{BK} holds. After that, when the calculator 5 determines that i=I_{BK} holds at Step S31, the series of operations proceeds to Step S6 of FIG. 9.

FIG. 11 is a flowchart showing specific operations at Step S3 in FIG. 9. With reference to FIG. 11, after Step S1 in FIG. 9, the calculator 5 sets j=1 at Step S41.

At Step S42, the calculator 5 detects background pixel values P₁ and P₂, in the imaging region PHG_REG, for estimating a background pixel value of a background pixel Pⱼ in the image processing region 1.

At Step S43, by Expression (7) and on the basis of the background pixel values P1 and P₂, the calculator 5 calculates the background pixel value of the background pixel Pj.

At Step S44, the calculator 5 determines whether j=J_{BK} holds. Here, J_{BK} is the total number of pixels Pi (background pixels) whose background pixel values are to be calculated in the image processing region 1.

If the calculator 5 determines at Step S44 that j=J_{BK} does not hold, the calculator 5 sets j=j+1 at Step S45. After that, a series of the operations proceeds to Step S42. Steps S42 to S45 are repeated until the calculator 5 determines at Step S44 that j=J_{BK} holds.

If the calculator 5 determines at Step S44 that j=J_{BK} holds, the calculator 5 sets k=1 at Step S46.

At Step S47, the calculator 5 detects background pixel values Q₁, Q₂, Qₐ, and Q_{b}, in the image processing region 1, for estimating a background pixel value of a background pixel Pk in the image processing region 2.

At Step S48, by Expression (8) and on the basis of the background pixel values Q₁, Q₂, Qₐ, and Q_{b}, the calculator 5 calculates the background pixel value of the background pixel Pk.

At Step S49, the calculator 5 determines whether k=K_{BK} holds. Here, K_{BK} is the total number of pixels Pk (background pixels) whose background pixel values are to be calculated in the image processing region 2.

If the calculator 5 determines at Step S49 that k=K_{BK} does not hold, the calculator 5 sets k=k+1 at Step S50. After that, a series of the operations proceeds to Step S47. Steps S47 to S50 are repeated until the calculator 5 determines at Step S49 that k=K_{BK} holds.

If the calculator 5 determines that k=I_{BK} holds at Step S49, the series of operations proceeds to Step S4 of FIG. 9.

FIG. 12 is a flowchart showing specific operations at Step S4 in FIG. 9. With reference to FIG. 12, after Step S3 in FIG. 9, the calculator 5 converts at Step S51 the pixel coordinates P(x, y) of the original image into the calculation pixel coordinates P(x\hat{ }, y\hat{ }).

At S52, the calculator 5 executes a convolution operation, using a background pixel value having the calculation pixel coordinates P(x\hat{ }, y\hat{ }) and a noise filter.

At Step S53, the calculator 5 converts the calculation pixel coordinates P(x\hat{ }, y\hat{ }) into the pixel coordinates P(x, y) of the original image. After that, a series of the Operations proceeds to Step S5 of FIG. 9.

FIG. 13 is a flowchart showing specific operations at Step S5 in FIG. 9. With reference to FIG. 13, after Step S4 in FIG. 9, the calculator 5 converts at Step S61 the pixel coordinates P(x, y) of the original image into the calculation pixel coordinates P(x\hat{ }, y\hat{ }).

At Step S62, the calculator 5 calculates a weight of the image processing filter, on the basis of the order c_re of the image processing filter and the calculation pixel coordinates P(x\hat{ }, y\hat{ }).

At S63, the calculator 5 executes a convolution operation, using the image processing filter and the calculation pixel coordinates P(x\hat{ }, y\hat{ }).

At Step S64, the calculator 5 converts the calculation pixel coordinates P(x\hat{ }, y\hat{ }) into the pixel coordinates P(x, y) of the original image. After that, a series of the operations proceeds to Step S6 of FIG. 9.

When the foreground image is calculated in accordance with the flowchart illustrated in FIG. 9 (including the flowcharts illustrated in FIGS. 10 to 13), an accurate background image can be calculated from a small number of background pixel values. Such a feature makes it possible to improve accuracy in calculation of the foreground image. Furthermore, reducing the number of the background pixel values makes it possible to maximize the number of the image pixel values, contributing to curbing deterioration of the captured image caused by an arrangement of the background pixel values. Such a feature makes it possible to calculate the foreground image accurately.

In this embodiment of the present invention, the method for calculating a foreground image in accordance with the flowchart in illustrated in FIG. 9 (including the flowcharts illustrated in FIGS. 10 to 13) is a “method for processing an image.”

Moreover, in this embodiment of the present invention, the foreground image may be calculated by software. In this case, the calculator 5 includes a central processing unit (CPU), a read-only memory (ROM), and a random access memory (RAM). The ROM stores a program Prog_A executing steps of the flowchart illustrated in FIG. 9 (including the flowcharts illustrated in FIGS. 10 to 13).

The CPU reads the program Prog_A out of the ROM, and executes the read program Prog_A to calculate the foreground image. The RAM temporarily stores various calculation results obtained while the foreground image is calculated.

Furthermore, the program Prog_A may be recorded on, and distributed through, such recording media as compact disc (CD) and a digital versatile disc (DVD). When the storage medium storing the program Prog_A is inserted into a computer, the computer reads the program Prog_A out of the storage medium and executes the program Prog_A to calculate the foreground image.

Hence, the storage media containing the program Prog_A is a computer-readable storage medium.

Note that, in this embodiment, an electromagnetic wave is detected. The electromagnetic wave can have a wavelength within a specific wavelength range. For example, when the detection wavelength is a wavelength of light, the optical system is easily designed. Accordingly, the light is easily detected. Here, the light means light in broad sense, and is an electromagnetic wave having a wavelength ranging from 1 nm to 1 mm. Moreover, when the detection wavelength is a wavelength of infrared light, the first embodiment makes it possible to remove infrared light emitted from the housing 1 because of a temperature of the housing 1, and to calculate an image of the object 30. Furthermore, such a feature makes it possible to recognize the object 30 in the dark. In particular, when a wavelength ranging from 6 to 20 μm is detected, the first embodiment makes it possible to effectively remove the infrared light to be emitted from the housing 1 at room temperature.

Advantageous Effects on Detection of Electromagnetic Wave, Light, and Infrared Light

Advantageous effects of the first embodiment will be described below for each of the detection wavelengths of a camera. The first embodiment can be implemented with a camera to detect electromagnetic waves, light and infrared light. As to a camera to detect light, the optical system is easily designed and the light is easily detected. Moreover, a camera to detect infrared light can remove infrared light emitted from the housing 1 because of a temperature of the housing 1, and calculate an image of the object 30. Furthermore, such a feature makes it possible to recognize the object 30 in the dark. In particular, when a wavelength ranging from 6 to 20 μm is detected, the camera can effectively remove the infrared light to be emitted from the housing 1 at room temperature.

Advantageous Effects on Detection Wavelength of Imaging Element

Advantageous effects of the first embodiment will be described below when an optical filter limits a detection wavelength of the imaging element 31. The optical filter limits the detection wavelength of the imaging element 31, making it possible to adjust an intensity of the infrared light emitted from the object 30 and incident on the imaging element 31, and an intensity of the infrared light emitted from the background and incident on the imaging element 31. Furthermore, for example, the optical filter limits the detection wavelength of the imaging element 31 to equalize the detection wavelength range of the imaging element 31 with the transmissive wavelength range of the lens 2. The equalization makes it possible to maximize the intensity of the infrared light emitted from the object 30 and incident on the imaging element 31, and to minimize the intensity of the infrared light emitted from the background and incident on the imaging element 31. Such a feature makes it possible to maximize the signal and minimize the noise. In other words, the feature improves the S/N. These advantageous effects can be achieved by equalization of the detection wavelength range of the imaging element 31 with the transmissive wavelength range of the lens 2. However, the detection wavelength range and the transmissive wavelength range do not have to be completely equalized with each other. When the rate of the equal ranges increases, the advantageous effects can be achieved in accordance with the increased rate.

Advantageous Effects on Detection Wavelength of Background Element

Described below are advantageous effects of the first embodiment when an optical filter limits a detection wavelength of the background element 32. The background element 32 needs to be designed so that the detection wavelength of the background element 32 does not include a transmissive wavelength range of the lens 2. Hence, a transmissive wavelength of an optical filter to be attached to the background element 32 shall not include the transmissive wavelength range of the lens 2. In addition to the above constraint, the transmissive wavelength of the optical filter may further be set narrower. Such a feature makes it possible to adjust an intensity of infrared light emitted from the background and incident on the background element 32. For example, when the transmissive wavelength of the optical filter is adjusted, the intensity of the infrared light emitted from the background and incident on the background element 32 can match the intensity of the infrared light emitted from the background and incident on the imaging element 31. Such a feature makes it possible to accurately remove the background. Note that, these advantageous effects can be achieved when the intensity of the infrared light emitted from the background and incident on the background element 32 matches the intensity of the infrared light emitted from the background and incident on the imaging element 31. However, these intensities do not have to completely match. When the rate of the matching ranges increases, the advantageous effects can be achieved in accordance with the increased rate.

Advantageous Effects on Detector Array Including Both Imaging Element and Background Element

In the first embodiment, the imaging elements 31 and the background elements 32 are arranged in mutually different positions so that the object 30 and the background can be captured simultaneously. Moreover, when the background elements 32 and the imaging elements 31 are provided to a single detector array, the background (attributed to the infrared light that the housing 1 emits, a temperature of the detector, and a thermal environment of surroundings) of the background elements 32 becomes closest to the background of the imaging elements 31. That is, such an arrangement makes it possible to remove the background of the imaging elements 31 most accurately.

Advantageous Effects on Simultaneous Imaging of Object and Background

Described below are advantageous effects of simultaneous imaging of an object and the background according to the first embodiment, compared with a method for calibration using a shutter (i.e. the invention cited in Japanese Unexamined Patent Application Publication No. 2017-126812).

A typical infrared camera is equipped with a shutter. The infrared camera captures an object when the shutter opens, and performs calibration to capture the background when the shutter closes. The opening and closing of, and the calibration by, the shutter produce a time period in which the object cannot be captured (i.e. a dead time in capturing). Moreover, images of the object and the background cannot be simultaneously obtained. If the images of the object and the background are obtained at different time points, temperatures and temperature distributions of the detector array, the camera housing, and the lens vary, inevitably causing an error on an image of a foreground to be calculated.

In order to reduce the dead time in capturing or to capture the object and the background as simultaneously as possible, the shutter needs to open and close at high speed. However, such high-speed opening and closing of the shutter requires a dedicated mechanism, resulting in an increase in production costs.

Meanwhile, in the first embodiment, the shutter is not used, and no dead time in capturing is produced. Such a feature makes it possible to continuously obtain infrared images at a high frame rate.

Furthermore, in the first embodiment, the object and the background can be simultaneously captured. Such a feature makes it possible to accurately calculate a foreground image even if the temperatures and the temperature distributions of the detector array, the camera housing, and the lens vary.

Advantageous Effects on Removal of Two-Dimensional Distribution of Background Pixel Values

In the first embodiment, an influence of the background can be removed from the captured image even if the background pixel values are distributed two-dimensionally.

Typical background pixel values of an infrared camera are influenced by temperatures and temperature distributions of the detector array the camera housing, and the lens. For example, when the temperature distributions are observed of the detector array, the camera housing, and the lens because of temperature distributions and variations in an environment around the infrared camera, the background pixel values are distributed two-dimensionally.

In the first embodiment, the background image can be accurately calculated even if the background pixel values are distributed two-dimensionally. As a result, the foreground image can be calculated accurately. That is, even if operating under a complex temperature environment, the infrared camera can accurately calculate the foreground image.

First Verification Experiment

Objects and Details of Verification

A verification is conducted to find out whether a captured image and a background image can be interpolated by the image processing in the flowchart of FIG. 9 (including the flowcharts in FIGS. 10 to 13). The camera may have any given configuration. That is, the configuration of the camera may be either the one in FIG. 4A or in FIG. 48.

Comparison with Known Technique

A known technique can accurately calculate a captured image from a detection value of an imaging element. (See (2) Image Processing (Captured image) for confirmation.) Meanwhile, a background image cannot be accurately calculated from a detection value of a background element. (See (3) Image Processing (a background image in the conventional technique) for confirmation because no preprocess: “estimation of a pixel value in an image processing region” is carried out.) From these viewpoints, advantageous effects of the present application are confirmed. (See (4) Image Processing (a background image in the present application).)

(1) Precondition for Verification

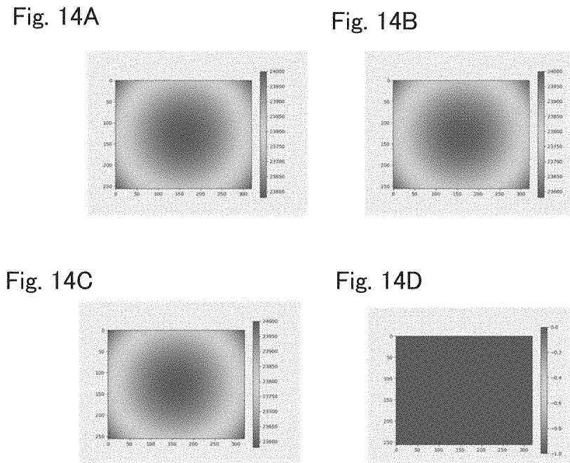

FIGS. 14A-14D show images of a first verification experiment. The number of detection elements in a detector array (the sum of the numbers of imaging elements and background elements) is 256×320. Of the detection elements of the detector array, the background elements are arranged in the detector array at offsets of m0=n0=4 and at intervals of m=n=8. Here, the number of the background elements is 32×40. Meanwhile, the imaging elements are detection elements in the detector array other than the background elements.

A verification image was prepared to have a pixel value (x, y)=0.01×[(x−128)²+(y−160)²]+24000. (See FIG. 14A.) In FIG. 14A, the minimum pixel value is 23580, the maximum pixel value is 24000, and the distribution of pixel value is 420 (=24000−23500).

Verified was whether this verification image can be restored when the image is used as a captured image and a background image. Note that “x” represents a horizontal pixel position and “y” represents a vertical pixel position.

(2) Image Processing (Captured Image)

Described below is processing of a captured image detected, using the imaging elements. The captured image (see FIG. 14B) misses pixel values where the background elements are arranged. Hence, the first-order average filter indicated by Expression (1) was applied to the detected captured image to estimate the missing pixel values.

The verification image (see FIG. 14A) was subtracted from the estimated captured image (see FIG. 14C). The obtained result was an image shown in FIG. 14D. Here, the maximum difference in pixel value is 1 between the estimated captured image and the verification image. That is, the processing on the captured image can interpolate the image pixel values with an accuracy of approximately 99.8% (=100−(1/420)×100).

(3) Image Processing (Background Image in Conventional Technique)

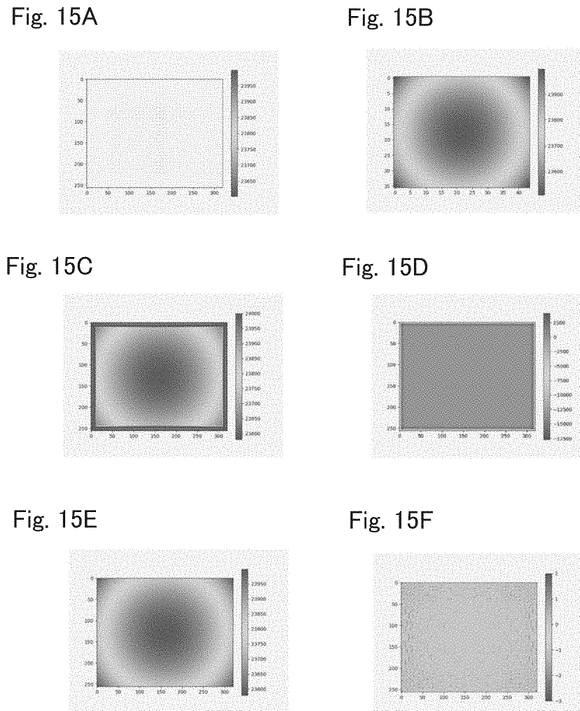

FIGS. 15A-15F show images that have undergone image processing in the first verification experiment. Resizing was performed with a conventional technique (without a preprocess). FIG. 15A shows a background image to be detected by the background elements. (The background image misses pixel values of pixels where the imaging elements are arranged.) FIG. 15B shows an image only of extracted pixel values detected by the background elements presenting the image of FIG. 15A. Resizing was performed on the image. The obtained result was FIG. 15C. Here, a second-order Lanczos filter was applied for the resizing.

The verification image (see FIG. 14A) was subtracted from the background image (see FIG. 15C) estimated on the basis of the conventional technique. The obtained result was FIG. 15D. Here, the maximum difference in pixel value is 27737 between the estimated background image and the verification image. That is, the background image cannot be accurately calculated.

(4) Image Processing (Background Image in First Embodiment)

Resizing was performed with the technique of the first embodiment. The processing until FIG. 15B was performed, using the same method as that used in the conventional technique. The image in FIG. 15B underwent a preprocess, using a second-order postprocess filter. In the preprocess, Expression (7) was applied to calculate the background pixel values of the image processing regions 1 in FIG. 5, and Expression (8) was applied to calculate the background pixel values of the image processing regions 2 in FIG. 5. After that, resizing with the Lanczos filter (2) was performed as a postprocess to calculate the background pixel values in the imaging region. As a result, FIG. 15E was obtained.

The verification image (see FIG. 14A) was subtracted from the estimated background image (see FIG. 15E). The obtained result was an image of FIG. 15F. Here, the maximum difference in pixel value is 3 between the estimated background image and the verification image. That is, the processing on the background image can interpolate the background pixel values an accuracy of approximately 99.3% (=100=(3/420)×100).

(4) Results

As can be seen, the method in the first embodiment was confirmed to accurately calculate the captured image and the background image. The example of the conventional technique produces a significantly large calculation error on edges of the images. Hence, the advantageous effects of the method in the first embodiment were confirmed.

Second Verification Experiment

Objects and Details of Verification

A verification is conducted to find out whether the background in a captured image can be removed, using the configuration FIG. 4B and the image processing in the flowchart of FIG. 9 (including the flowcharts in FIGS. 10 to 13). Moreover, a verification is conducted to find out whether a background image can be accurately calculated by the denoising in the flowchart of FIG. 9 (including the flowcharts in FIGS. 10 to 13).

Comparison between First Verification Experiment and Second Verification Experiment

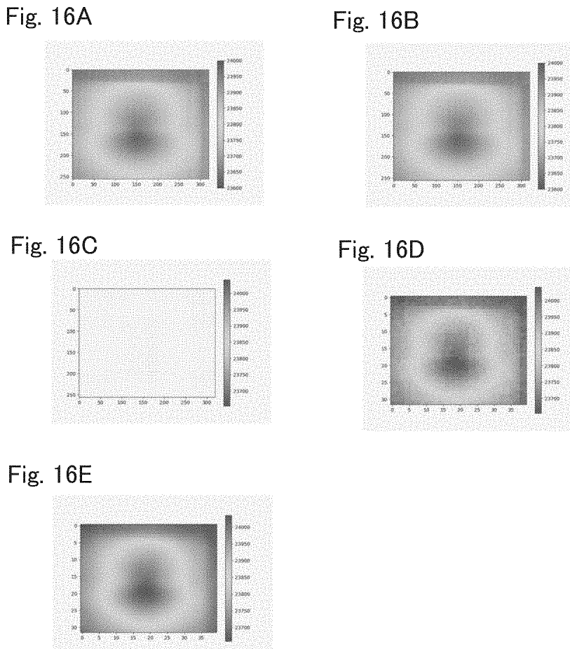

FIGS. 16A-16E show images of a second verification experiment. As seen in the first verification experiment, the second verification experiment verified interpolation of a captured image and a background image in accordance with the flowchart of FIG. 9 (including the flowcharts in FIGS. 10 to 13). Note that, in the second verification experiment, an image actually Obtained with an infrared camera (see FIGS. 16A and 16C) is used to verify the advantageous effects of the first embodiment.

(1) Precondition for Verification

Principles were verified, using an infrared camera including a detector array having 256×370 detection elements.

A captured image (see FIG. 16A) and a background image (see FIG. 16C) were obtained with an infrared camera whose configuration is shown in FIG. 4B.

As to the configuration of the infrared camera, a wavelength range of infrared light transmitting through the lens is from 8 to 14 μm, a detection wavelength range of each detection element is from 5 to 20 μm, a wavelength range of the optical filter FLT 2 for each imaging element is from 8 to 9.5 μm, and a wavelength range of the optical filter FLT 1 for each background element is from 6.25 to 6.75 μm. Hence, the infrared light emitted from an object enters only the imaging elements, but not the background elements.

Of the detection elements of the detector array in the infrared camera, the background elements were arranged at offsets of m0=n0=4 and at intervals of m=n=8. Here, the number of the background elements is 32×40. Meanwhile, the imaging elements are detection elements in the detector array other than the background elements.

A verification image was obtained to show a black object at room temperature.

FIG. 16A is a captured image obtained, using the imaging elements. FIG. 16A shows infrared light emitted from the black object and infrared light emitted from the background. Here, the entire field of view of the lens is covered with the black object at a uniform temperature (at room temperature). Hence, a correct image (i.e. a foreground of the captured image with the background image removed) is an image of the black object at a uniform temperature (at room temperature). In other words, the temperature distribution in FIG. 16A is caused entirely by the background. Note that a white portion in FIG. 16A is a region missing image pixel values because of the background elements.

In FIG. 16A, the minimum image pixel value (a specific pixel value on the top-right of the image) is 23622 and the maximum image pixel value (a specific pixel value in the center of the image) is 23998. Hence, pixel values of 366 (23998-23622) are two-dimensionally distributed. A pixel value on the four edges of FIG. 16A is smaller than a pixel value in the center of the image.

Meanwhile, FIG. 16C is a background image obtained, using the background elements. FIG. 16C shows only infrared light emitted from the background. Note that a white portion in FIG. 16C is a region missing background pixel values because of the imaging elements. FIG. 16D is FIG. 16C from which the background pixel values are extracted. (FIG. 16D) has undergone the normalization of pixel intervals in the above preprocess 1.) Here, the camera and the object are at room temperature, and the images FIGS. 16A and 16C with the pixel values interpolated are ideally identical images.

In the verification, the missing pixels were interpolated using the captured image and the background image, and the foreground was calculated. The captured image and the background image are almost identical. Hence, the closer the pixel values of the foreground are to 0, the higher the calculation accuracy is.

(2) Image Processing (Captured Image)

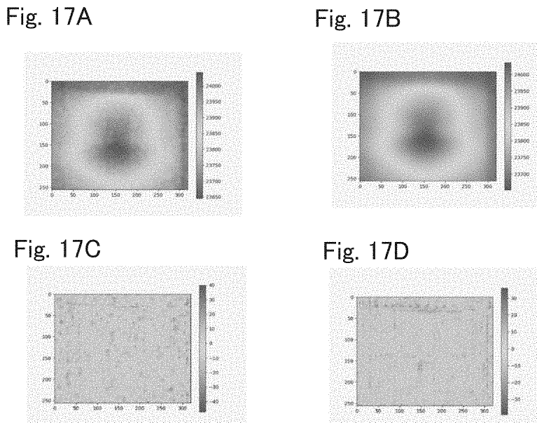

FIGS. 17A-17D show images that have undergone image processing in the second verification experiment. Described below is processing of a captured image (see FIG. 16A) detected, using the detection elements for detecting the object.

The first-order average filter indicated by Expression (1) was applied to the detected captured image to estimate the image pixel values of the pixels corresponding to the positions of the background elements. (See FIG. 16B).

(3) Image Processing (Background Image)

Described below is processing of a background image (see FIG. 16D) detected, using the background elements. A preprocess was performed on the detected background image, while the number of pixels k to be added in each of the directions of the image processing regions 1 and 2 was determined 3. In the preprocess, Expression (7) was applied to calculate the background pixel values of the image processing regions 1, and Expression (8) was applied to calculate the background pixel values of the image processing regions 2.

FIG. 17A is a result of calculation of background pixel values in the imaging region, using the second-order Lanczos(2) filter without denoising.

FIG. 16E is FIG. 16D after denoising. The denoised image of FIG. 16E has less variation caused by the noise of FIG. 16D. The Lanczos(2) filter of order 2 is applied to FIG. 16E to calculate the background pixel values of the imaging region, and FIG. 17B is obtained.

(4) First Calculation of Foreground Image

Described first is the foreground image; that is, the captured image from which the background image is subtracted.

When the pixel values of FIG. 17A were subtracted from the pixel values of FIG. 16B and the foreground image was calculated, a minimum foreground pixel value was −101, a maximum foreground pixel value was 33, an average foreground pixel value was −33.4, and a standard deviation was 16.2. (See FIG. 17C). That is, the foreground pixel values were successfully calculated in the image processings (2) and (3) with an accuracy of approximately 72.4% (=100−(101/366)×100).

Meanwhile, when the pixel values of FIG. 17B were subtracted from the pixel values of FIG. 16A, and the foreground image was calculated, a minimum foreground pixel value was 87, a maximum foreground pixel value was 30, an average foreground pixel value was 31.5, and a standard deviation was 14.6. (See FIG. 17D.) That is, the foreground pixel values were successfully calculated in the image processings (2) and (3) with an accuracy of approximately 76.3% (=100−(87/366)×100). In view of all such indexes as a minimum value, a maximum value, an average value, a standard deviation and an accuracy of the foreground pixel values, the denoised background image (see FIG. 17B) contributes to more accurate calculation of the foreground image than the background image without denoising (see FIG. 17A) does.

### Second Embodiment

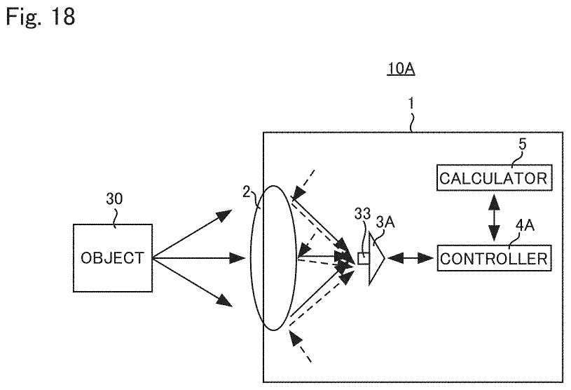

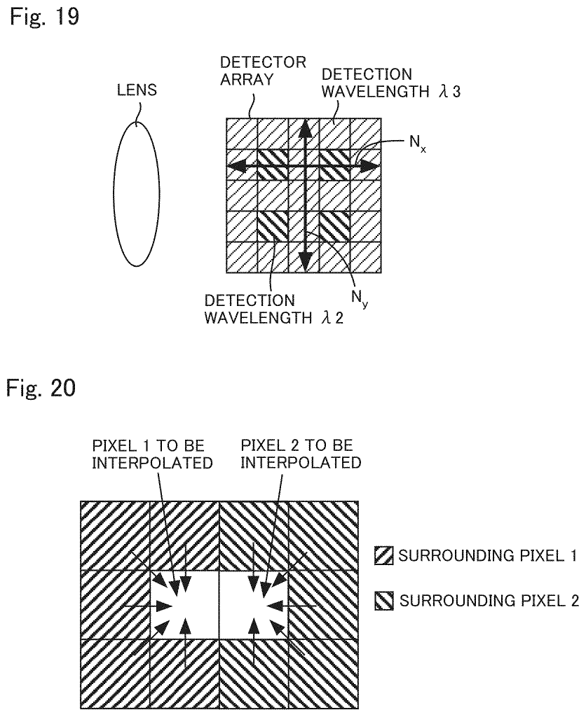

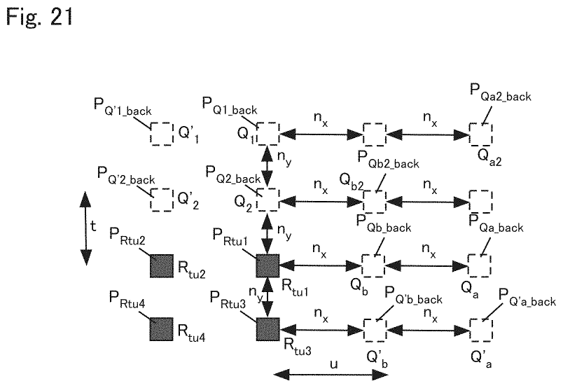

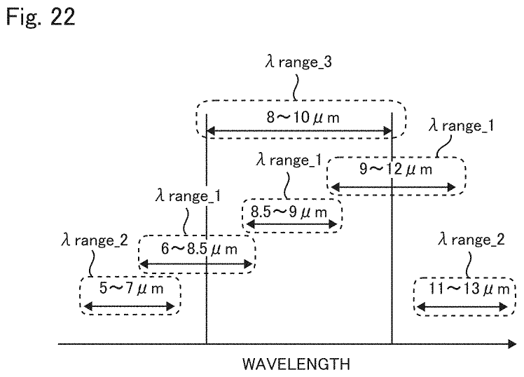

FIG. 18 is a schematic view of an infrared camera according to a second embodiment. With reference to FIG. 18, an infrared camera 10A according to the second embodiment is the same as the infrared camera 10 illustrated in FIG. 1 except for a detector array 3A and a controller 4A respectively replacing the detector array 3 and the controller 4.

The detector array 3A includes a plurality of quantum-dot infrared detection elements 33. The quantum-dot infrared detection elements 33 change a detection wavelength of infrared light depending on a voltage to be applied.

The quantum-dot infrared detection elements 33 include quantum-dot infrared detection elements 33-1 corresponding to the imaging elements 31 according to the first embodiment and quantum-dot infrared detection elements 33-2 corresponding to the background elements 32 according to the first embodiment.

When a voltage V1 is applied by the controller 4A, each of the quantum-dot infrared detection elements 33-1 detects infrared light with a detection wavelength λ3, and outputs to the controller 4A a detection value D3 of the detected infrared light. Moreover, when a voltage V2 applied by the controller 4A, each of the quantum-dot infrared detection elements 33-2 detects infrared light with the detection wavelength λ2, and outputs to the controller 4A a detection value D4 of the detected infrared light.

The controller 4A applies: the voltage V1 to the quantum-dot infrared detection element 33-1; and the voltage V2 to the quantum-dot infrared detection element 33-2. Furthermore, the controller 4A receives: the detection value D3 from the quantum-dot infrared detection element 33-1; and the detection value D4 from the quantum-dot infrared detection element 33-2. The controller 4A then outputs the received detection values D3 and D4 to the calculator 5. Other than that, the controller 4A performs the same functions as the controller 4 does.

In the infrared camera 10A, on the basis of the detection values D3 and D4 received from the controller 4A, the calculator 5 calculates a foreground image in accordance with the flowchart illustrated in FIG. 9 (including the flowcharts illustrated in FIGS. 10 to 13).

FIG. 19 is a plan view illustrating the detector array 3A illustrated in FIG. 18. Note that FIG. 19 is a plan view illustrating the detector array 3A observed from the lens 2.

With reference to FIG. 19, the detector array 3A includes: the quantum-dot infrared light detection elements 33-1 detecting infrared light with the detection wavelength λ3; and the quantum-dot infrared light detection elements 33-2 detecting infrared light with the detection wavelength λ2. The detection wavelength λ3 ranges, for example, from 8 to 10 μm, from 9 to 10 μm, or from 8 to 11 μm. Hence, the detection wavelength λ3 at least partially includes the detection wavelength λ1.

The quantum-dot infrared light detection elements 33-1 and 33-2 are arranged in an N_{y}×Nₓ matrix.

The infrared camera 110A achieves the advantageous effects below.
(1) Without a filter array, the infrared camera 10A can achieve the same advantageous effects as those of the first embodiment. That is, the infrared camera 10A eliminates the need of an optical member for limiting the wavelength range, making it possible to reduce the space inside the housing 1 and to increase flexibility in designing the optical system.
(2) The infrared camera 10A eliminates the need for selecting a detection element for a specific wavelength range, making it possible to increase flexibility in selecting a detection wavelength and in designing. Hence, the detection can be performed readily and effectively. For example, the flexibility increases in selecting the detection wavelength λ3 most suitable for detecting the object 30.
(3) In the configuration shown in FIG. 4B, damage to one of the background elements 32 has a significant influence on background pixel values in a large area. Specifically, the background elements 32 are sparsely arranged. Hence, when a background element 32 is damaged, the calculation accuracy of the background image significantly decreases. In the configuration illustrated in FIG. 19, however, even if the quantum-dot infrared detection elements 33-2 to detect the background image are damaged, such elements can be changed. This is because the detector array 3A can detect a captured image or a background image by changing a voltage to be applied to the quantum-dot infrared detection elements. Hence, even if the quantum-dot infrared detection elements 33-2 to detect the background image are damaged, the significant influence on the background image can be reduced.

Other descriptions of the second embodiment are the same as those of the first embodiment.

FIG. 20 is a conceptual illustration of how to interpolate an imaging pixel with another technique. In the first embodiment, each of the background elements 32 (or the quantum-dot infrared light detection elements 33-2) is spaced apart from one another at a predetermined interval (nₓ or n_{y}). In this embodiment, however, the arrangement of the background elements 32 is not limited to such an arrangement. Neighboring pairs of background elements 32 may each be spaced apart from one another at a predetermined interval (nₓ or n_{y}). In such a case, a pixel value of a captured image corresponding to the pair of the background elements 32 (or the quantum-dot infrared light detection elements 33-2) is interpolated as follows.

With reference to FIG. 20, pixels 1 and 2 to be interpolated are adjacent to each other. Here, when a pixel value of the pixel 1 is interpolated, a convolution operation is performed on surrounding pixels 1 around the pixel 1 by Expression (2) or Expression (6), using pixel values of surrounding pixels 1 and the above image processing filter (an odd-order average filter or an even-order average filter). The pixel values of the surrounding pixels 1 are averaged by the convolution operation, and interpolated as the pixel value of the pixel 1. Furthermore, when a pixel value of the pixel 2 is interpolated, a convolution operation is performed on surrounding pixels 2 around the pixel 2 by Expression (2) or Expression (6), using pixel values of surrounding pixels 2 and the above image processing filter (an odd-order average filter or an even-order average filter). The pixel values of the surrounding pixels 2 are averaged by the convolution operation, and interpolated as the pixel value of the pixel 2.

FIG. 21 is a drawing illustrating another technique of how to calculate a background pixel value in an image processing region 2. With reference to FIG. 21, the background pixel value Rₜᵤ₁ of the background pixel P_{Rtu1} may be calculated by Expression (7), using a background pixel value Q_{b2} of a background pixel P_{Qb2_back} and a background pixel value Qₐ₂ of a background pixel P_{Qa2_back}.

The background pixel P_{Qb2_back} is positioned closest in the image processing regions 1 to the background pixel P_{Rtu1} along a diagonal of the imaging region. The background pixel P_{Qa2_back} is positioned second closest in the image processing regions 1 to the background pixel P_{Rtu1} along the diagonal of the imaging region. Pixel intervals between the background pixel P_{Qa2_back} and the background pixel P_{Qb2_back} and between the background pixel P_{Qb2_back} and the background pixel P_{Rtu1} are ((Nₓ)²+(N_{y})²))^{1/2}. The pixel interval (=((Nₓ)²+(N_{y})²))^{1/2}) between background pixel P_{Qb2_back} and the background pixel P_{Rtu1} is divided by the pixel interval (=((Nₓ)²+(N_{y})²))^{1/2}) along the diagonal of the imaging region, such that the value “s” is “1”.

Hence, the background pixel values Qₐ₂ and Q_{b2}, and s=1 are substituted for Expression (7), and the background pixel value Rₜᵤ₁ (=Q_{b2}−Qₐ₂+Q_{b2}) is calculated.

Moreover, the background pixel value Rₜᵤ₄ of the background pixel P_{Rtu4} may also be calculated by Expression (7), using the background pixel value Q_{b2} of the background pixel P_{Qb2_back} and the background pixel value Qₐ₂ of the background pixel P_{Qa2_back}.

The background pixel P_{Qb2_back} is positioned closest in the image processing regions 1 to the background pixel P_{Rtu4} along a diagonal of the imaging region. The background pixel P_{Qa2_back} is positioned second closest in the image processing regions 1 to the background pixel P_{Rtu4} along the diagonal of the imaging region. A pixel interval between the background pixel P_{Rtu1} and the background pixel P_{Rtu4} is also ((Nₓ)²+(N_{y})²))^{1/2}. The pixel interval (=2×((Nx)²+(Ny)²))^{1/2}) between the background pixel P_{Qb2_back} and the background pixel P_{Rtu2} is divided by the pixel interval (=((Nx)²+(Ny)²))^{1/2}) along the diagonal of the imaging region, such that the value “s” is “2”.

Hence, the background pixel values Qₐ₂ and Q_{b2}, and s=2 are substituted for Expression (7), and the background pixel value Rₜᵤ₄ (=2×(Q_{b2}−Qₐ₂)+Q_{b2}) is calculated.

Note that the background pixel value Rₜᵤ₂ of the background pixel P_{Rtu2} and the background pixel value Rₜᵤ₃ of the background pixel P_{Rtu3} are calculated by the method illustrated in FIG. 8.

The method illustrated in FIG. 21 can calculate the background pixel values Rₜᵤ₁ and Rₜᵤ₄, reflecting distribution of background pixel values found along the diagonals of the imaging region. Moreover, the method illustrated in FIG. 21 can calculate the background pixel values Rₜᵤ₁ and Rₜᵤ₄ with a smaller amount of calculation than the method illustrated in FIG. 8 does.

FIG. 22 is a conceptual illustration showing a relationship between wavelength ranges of infrared light according to the embodiments of the present invention. In the embodiments, the detection wavelength λ1 with which the imaging element 31 detects infrared light ranges from 8 to 10 μm, and the detection wavelength 12 with which the imaging element 32 detects infrared light ranges from 10 to 11 μm. Moreover, in the embodiments, the detection wavelength λ1 may include the transmissive wavelength range of the lens 2, and the detection wavelength λ1 may match the transmissive wavelength range of the lens 2. Furthermore, in the embodiments, the background element 32 is formed of a detection element and the optical filter FLT 1 attached to the detection element. The optical filter FLT 1 is transparent to the detection wavelength λ2, and blocks infrared light in the transmissive wavelength range of the lens 2.

Hence, the wavelength range in which the imaging element 31 can detect infrared light may at least partially overlap the transmissive wavelength range of the lens 2. Moreover, the wavelength range in which the background element 32 can detect infrared light does not overlap the transmissive wavelength range of the lens 2. The optical filter FLT 1 attached to the detection element makes the wavelength range, in which the background element 32 can detect infrared light, not to overlap the transmissive wavelength range of the lens 2.

In FIG. 22, the wavelength ranges of 6 to 8.5 μm, 8.5 to 9 μm, and 9 to 12 μm are examples of wavelength range λrange_1 in which the imaging element 31 can detect infrared light. Moreover, the wavelength ranges of 5 to 7 μm and 11 to 13 μm are examples of wavelength range λrange_2 in which the imaging element 32 can detect infrared light. Furthermore, the wavelength range of 8 to 10 μm is a wavelength range λrange_3 which is the transmissive wavelength range of the lens 2. Here, the wavelength ranges λrange_1 and λrange_2 may partially overlap.

Hence, the wavelength range λrange_1 (any one of the ranges of 6 to 8.5 μm, 8.5 to 9 μm, and 9 to 12 μm), in which the imaging element 31 can detect the infrared light, at least partially overlaps the wavelength range λrange_3 (the range of 8 to 10 μm) which is the transmissive wavelength range of the lens 2. Moreover, the wavelength range λrange_2 (the range of 5 to 7 μm, or of 11 to 13 μm), in which the background element 32 can detect the infrared light, does not overlap the wavelength range λrange_3 (the range of 8 to 10 μm) which is the transmissive wavelength range of the lens 2. The optical filter FLT 1 obtains the wavelength range λrange_2 (the range of 5 to 7 μm, or of 11 to 13 μm) in which the background element 32 can detect the infrared light.

As a result, when the wavelength range λrange_1 in any one of 6 to 8.5 μm, 8.5 to 9 μm, and 9 to 12 μm is a first wavelength range, the wavelength range λrange_2 of 5 to 7 μm, or of 11 to 13 μm is a second wavelength range, and the wavelength range λrange_3 of 8 to 10 μm is a third wavelength range, a camera according to the embodiments of the present invention may include:
(1) a first detection unit including first detection elements arranged two-dimensionally and detecting an electromagnetic wave within a first wavelength range λrange_1;
(2) a second detection unit including second detection elements arranged two-dimensionally and detecting an electromagnetic wave emitted from an inside of a housing, the electromagnetic wave having at least one of wavelengths within a second wavelength range λrange_2;
(3) a first transparent member provided to correspond to the second detection elements and allowing the electromagnetic wave within the second wavelength range λrange_2 to pass through the first transparent member;
(4) a second transparent member allowing an electromagnetic wave within a third wavelength range λrange_3 to pass through the second transparent member from an outside to the inside of the housing; and
(5) a calculator calculating image information from a first detection value detected by the first detection unit and a second detection value detected by the second detection unit.
(6) The first wavelength range λrange_1 includes at least one wavelength overlapping a wavelength within the third wavelength range λrange_3.
(7) The second wavelength range λrange_1 does not overlap the third wavelength range λrange_3.

The camera may detect not only infrared light but also electromagnetic waves. This is because the camera includes the features (1) to (7), so that the wavelength range λrange_3 (i.e. a first wavelength range that overlaps a third wavelength range with at least one wavelength), in which the first detection elements detect an electromagnetic wave emitted from the object 30, does not overlap the wavelength range λrange_2 (i.e. the second wavelength range) in which the second detection elements detect an electromagnetic wave emitted from a background. Hence, the image information is calculated from the first detection value detected by the first detection unit (the first detection elements) and from the second detection value detected by the second detection unit (the second detection elements), a and such image information is accurate.

In the embodiments of the present invention, the imaging elements 31 two-dimensionally arranged in the detector array 3 serves as the “first detection unit”, and the background elements 32 two-dimensionally arranged in the detector array 3 serves as the “second detection unit”.

Moreover, in the embodiments of the present invention, the optical filter FLT 1 serves as the “first transparent member” disposed to correspond to each of the background elements 32 (the second detection elements) and transparent to the electromagnetic wave within the second wavelength range λrange_2. The lens 2 serves as the “second transparent member” transparent to the electromagnetic wave within the third wavelength range λrange_3 transmitting from the outside to the inside of the housing 1.

Furthermore, a background pixel value of a background image serves as a “first background pixel value” detected by the background elements 32 or the quantum-dot infrared light detection elements 33-2.

Furthermore, in the embodiments of the present invention, the background pixel values Qₛ and Rₜᵤ serves as a “second background pixel value”.

Moreover, in the embodiments of the present invention, the background pixel values Qₛ and Rₜᵤ and a background pixel value of a background image, which are detected by the background elements 32 or the quantum-dot infrared light detection elements 33-2, serve as a “third background pixel value”.

In addition, in the embodiments of the present invention, the background pixels P_{Q1_back}, P_{Q2_back}, P_{Q′1_back}, and P_{Q′2_back} serve as a “first target background image”. The background images P_{2_back} and P_{2′_back} serve as a “first background image”. The background pixel values P₂ and P_{2′} serve as a “fourth background pixel value”.

Furthermore, in the embodiments of the present invention, the background pixels P_{Rtu1} and P_{Rtu2} serve as a “second target background image”. Each of the background pixels P_{Qb_back} and P_{Q′b_back} serves as a “second background image”. Each of the background pixels P_{Q2_back} and P_{Q′2_back} serves as a “third background image”. Each of the background pixel values Q_{b} and Q′_{b} serves as a “fifth background pixel value”. The background pixel values Qₐ₁ to Qᵤ₄ serve as a “sixth background pixel value”. Each of the background pixel values Q₂ and Q′₂ serves as a “seventh background pixel value”. The background pixel values Rₜ₁ to Rₜ₄ serve as an “eighth background pixel value”.

In addition, in the embodiments of the present invention, a “first processing” involves calculating the background pixel values Qₛ and Rₜᵤ in accordance with the background pixel value, of the background image, detected by the background elements 32 or the quantum-dot infrared light detection elements 33-2.

Moreover, in the embodiments of the present invention, a “second processing” involves calculating background pixel values in all the image region in accordance with the background pixel values Qₛ and Rₜᵤ, and the background pixel value, of the background image, detected by the background elements 32 or the quantum-dot infrared light detection elements 33-2.

Furthermore, in the embodiments of the present invention, a “third processing” involves calculating background pixel values of the background pixels P_{2_back} and P_{2′_back}, and a “fourth processing” involves calculating background pixel values of the background pixels P_{Rtu1} and P_{Rtu2}.

Step S3 in FIG. 9 (Steps S41 to S50 in FIG. 11) includes: a step of calculating the second background pixel value in accordance with the first background pixel value, the first background pixel being a pixel value, of the background image, detected by the second detection elements (the background elements 32) and the second background pixel value being a background pixel value in an image processing region outside the imaging region; and a step of interpolating, in accordance with the first and second background pixel values, a background pixel value of an image corresponding to the first detection elements (the imaging elements 31), and calculating the third background pixel value that is a background pixel value of all the imaging region.

Moreover, Step S2 in FIG. 9 (Steps S21 to S32 in FIG. 10) includes a step of: interpolating an image pixel value of the image corresponding to the second detection elements (the background elements 32) and calculating an image pixel value of all the imaging region, the interpolating being performed in accordance with an image pixel value, of a captured image, detected by the first detection elements (the imaging elements 31).

Furthermore, Step S6 in FIG. 9 includes a step of subtracting the third background pixel value from the image pixel value to calculate a foreground image.

In addition, Step S4 in FIG. 9 includes a step of performing denoising on the second background pixel value.

In addition, as seen in the flowchart illustrated in FIG. 9, the calculator 5 receives from the controller 4 the detection value D1 of the imaging element 31 and the detection value D2 of the background element 32. The reception is a step of receiving: the first background pixel value that is a pixel value, of the background image, detected by the second detection elements (the background elements 32); and the image pixel value that is a pixel value, of the captured image, detected by the first detection elements (the imaging elements 31).

The embodiments disclosed herewith are examples in all respects, and shall not be interpreted to be limitative. The scope of the present invention is intended to be determined not in the above embodiments, but in the claims. All the modifications equivalent to the features of, and within the scope of, the claims are to be included within the scope of the present invention. While there have been described What are at present considered to be certain embodiments of the invention, it will be understood that various modifications may be made thereto, and it is intended that the appended claims cover all such modifications as fall within the true spirit and scope of the invention.

### INDUSTRIAL APPLICABILTY

The present invention is applicable to a camera, a method for processing an image, a program, and a computer-readable storage medium containing the program.

What is claimed is:

1. A camera, comprising:
a first detection unit including a plurality of first detection elements arranged two-dimensionally and configured to detect an electromagnetic wave having a first wavelength range;
a second detection unit including a plurality of second detection elements arranged two-dimensionally and capable of detecting an electromagnetic wave emitted from an inside of a housing, wherein the electromagnetic wave has at least one wavelength within a second wavelength range;
a first transparent member disposed to correspond to the second detection elements and capable of transmitting an electromagnetic wave having at least the one wavelength within the second wavelength range;
a second transparent member capable of transmitting an electromagnetic wave having a third wavelength range from an outside to the inside of the housing; and
a calculator configured to calculate image information from a first detection value detected by the first detection unit and a second detection value detected by the second detection unit,
the first wavelength range including at least one wavelength overlapping a wavelength having the third wavelength range, and
the second wavelength range not overlapping the third wavelength range.

2. The camera according to claim 1, wherein
the first detection elements and the second detection elements are arranged in mutually different positions in an imaging region.

3. The camera according to claim 1, wherein
the first detection elements and the second detection elements are made of the same detection elements,
each of the first detection elements is provided with an optical filter, and
the optical filter has a transmissive wavelength range defined as the first wavelength range.

4. The camera according to claim 1, wherein
a ratio in number of the first detection elements to the second detection elements is equal to “64” to “one or less”.

5. The camera according to claim 1, wherein
the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

6. The camera according to claim 5, wherein
the first detection elements and the second detection elements are arranged in an N_{y}×Nₓ matrix in the imaging region,
the image processing region includes: a first image processing region including the background image including k×Nₓ background images arranged in a k×Nₓ matrix or N_{y}×k background images arranged in an N_{y}×k matrix, and disposed along a row or a column of the imaging region; and a second image processing region including the background image including k×k background images arranged in a k×k matrix, and positioned on an extension of a diagonal of the imaging region, and
the calculator executes a third processing on all of background pixels including the background pixel within the first image processing region, and a fourth processing on all of background pixels including the background pixel within the second image processing region, the third processing involving calculating a background pixel value of a first target background image so that, when, in the first processing, the background images in the imaging region includes a first background image disposed in the same row or the same column as, and closest to, the first target background image to calculate a background image pixel value in the first image processing region, a difference in background pixel value from a fourth background pixel value that is a background pixel value of the first background image becomes: large if a first image interval that is an image interval between the first background image and the first target background image becomes long; and small if the first image interval becomes short, and the fourth processing involving calculating a sixth background pixel value, an eighth background pixel value, and an average of the sixth background pixel value and the eight background pixel value as a background pixel value of a second target background pixel, the sixth background pixel value being calculated so that, when the background images in the first image processing region includes a second background image disposed in the same row as, and closest to, the second target background image to calculate a background pixel value in the second image processing region, and when the background images in the first image processing region include a third background image disposed in the same column as, and closest to, the second target background image, a difference in background pixel value from a fifth background pixel value that is a background pixel value of the second background image becomes: large if a second image interval that is an image interval between the second background image and the second target background image becomes long; and small if the second image interval becomes short, and the eighth background pixel value being calculated so that, a difference in background pixel value from a seventh background pixel value that is a background pixel value of the third background image becomes: large if a third image interval that is an image interval between the third background image and the second target background image becomes long; and small if the third image interval becomes short.

7. The camera according to claim 6, wherein
the calculator further executes denoising in the first processing after the third processing and the fourth processing

8. The camera according to claim 1, wherein
the electromagnetic wave detected by the first detection unit, the electromagnetic wave detected by the second detection unit, and the electromagnetic wave having the third wavelength are infrared light.

9. A method for processing an image, the method comprising:
a first step of calculating a second background pixel value in accordance with a first background pixel value, the first background pixel value being a pixel value, of a background image, detected by a plurality of second detection elements, and the second background pixel value being a background pixel value in an image processing region outside an imaging region;
a second step of interpolating, in accordance with the first background pixel value and the second background pixel value, a background pixel value of an image corresponding to a plurality of first detection elements, and calculating a third background pixel value that is a background pixel value of all the imaging region;
a third step of interpolating an image pixel value of an image corresponding to the second detection elements and calculating an image pixel value of all the imaging region, the interpolating being performed in accordance with an image pixel value, of a captured image, detected by the first detection elements; and
a fourth step of subtracting the third background pixel value from the calculated image pixel value to calculate a foreground image.

10. The camera according to claim 2, wherein
a ratio in number of the first detection elements to the second detection elements is equal to “64” to “one or less”.

11. The camera according to claim 2, wherein
the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

12. The camera according to claim 10, wherein
the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

13. A camera, comprising:
a first detection unit including a plurality of first detection elements arranged two-dimensionally and configured to detect an electromagnetic wave having a first wavelength range;
a second detection unit including a plurality of second detection elements arranged two-dimensionally and capable of detecting an electromagnetic wave emitted from an inside of a housing, wherein the electromagnetic wave has at least one wavelength within a second wavelength range;
a second transparent member capable of transmitting an electromagnetic wave having a third wavelength range from an outside to the inside of the housing; and
a calculator configured to calculate image information from a first detection value detected by the first detection unit and a second detection value detected by the second detection unit,
the first wavelength range including at least one wavelength overlapping a wavelength having the third wavelength range,
the second wavelength range not overlapping the third wavelength range, and
the first detection elements and the second detection elements are quantum-dot-based detection elements.

14. The camera according to claim 13, wherein
the first detection elements and the second detection elements are arranged in mutually different positions in an imaging region.

15. The camera according to claim 13, wherein
the quantum-dot-based detection elements include:
a first quantum-dot-based detection element to which a first voltage is applied, the first quantum-dot-based detection element being configured to detect an electromagnetic wave, emitted from an object, in the third wavelength range at least partially including the first wavelength range; and
a second quantum-dot-based detection element to which a second voltage that is different from the first voltage is applied, the second quantum-dot-based detection element being configured to detect an electromagnetic wave, emitted from an inside of the housing, in the second wavelength range.

16. The camera according to claim 13, wherein
a ratio in number of the first detection elements to the second detection elements is equal to “64” to “one or less”.

17. The camera according to claim 13, wherein
the calculator: executes a first processing that involves calculating a second. background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

18. The camera according to claim 14, wherein
a ratio in number of the first detection elements to the second detection elements is equal to “64” to “one or less”.

19. The camera according to claim 14, wherein
the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.

20. The camera according to claim 18, wherein
the calculator: executes a first processing that involves calculating a second background pixel value in accordance with a first background pixel value, the first background pixel value being a pixel value, of a background image, obtained from the second detection value, and the second background pixel value being a background pixel value in an image processing region outside an imaging region; executes a second processing that involves interpolating, in accordance with the first background pixel value and the second background pixel value, a background pixel value of an image corresponding to the first detection elements, and calculating a third background pixel value that is a background pixel value of all the imaging region; interpolates an image pixel value of an image corresponding to the second detection elements and calculates an image pixel value of all the imaging region, the interpolating being performed in accordance with an image pixel value, of a captured image, detected by the first detection elements; and subtracts the third background pixel value from the calculated image pixel value to calculate a foreground image.
